(19) United States
(12) Patent Application Publication
(10) Pub. No.: US 2025/0105541 A1
(43) Pub. Date: Mar. 27, 2025

(54) COMPACT HIGH-SPEED ELECTRICAL CONNECTOR AND ELECTRONIC SYSTEM THEREOF

(71) Applicant: Amphenol Commercial Products (Chengdu) Co., Ltd., Chengdu (CN)

(72) Inventors: Jun Fan, Chengdu (CN); Tao Zeng, Chengdu (CN); Ki Ka Lau, Kowloon (HK)

(73) Assignee: Amphenol Commercial Products (Chengdu) Co., Ltd., Chengdu (CN)

(21) Appl. No.: 18/890,066

(22) Filed: Sep. 19, 2024

(30) Foreign Application Priority Data
Sep. 21, 2023 (CN) 202311227305.1
Sep. 21, 2023 (CN) 202322577414.8

(51) Int. Cl. H01R 13/05; H01R 12/72; H01R 12/75; H01R 13/502; H01R 13/627; H01R 13/6471

(52) U.S. Cl. CPC H01R 13/05; H01R 12/75; H01R 13/502; H01R 13/6273; H01R 13/6471; H01R 12/721; H01R 12/724

(57) ABSTRACT

A compact high-speed electrical connector and electronic system thereof. The connecter comprises first, second, and third mating interfaces configured to receive one or more cards, and a mounting interface configured to mount to a substrate. The first, second, and third mating interfaces extend in columns parallel to each other and perpendicular to a mating direction. The first, second, and third mating interfaces offset from each other in a mating direction. The mounting interface extends in the mating direction. Such a configuration enables direction interconnections between three components that support hybrid functions such as high-speed signals, power, and/or side bands, while satisfying a limited space provided by an electronic system.

### CROSS-REFERENCE TO RELATED APPLICATIONS

This application claims priority to and the benefit of Chinese Patent Application No. 202322577414.8, filed on Sep. 21, 2023. This application also claims priority to and the benefit of Chinese Patent Application No. 202311227305.1, filed on Sep. 21, 2023. The contents of these applications are incorporated herein by reference in their entirety.

### TECHNICAL FIELD

The present disclosure generally to electrical electronic system, such as those including electrical connectors, used to interconnect electronic assemblies.

### BACKGROUND

Electrical connectors are used in electronic systems to connect circuitry on one printed circuit board (PCB) to circuitry on another PCB. For some systems, it may be easier and more cost effective to manufacture the majority of the system's circuitry on separate electronic assemblies, such as PCBs, which may be joined together with electrical connectors. A common example of this is memory cards that plug into electrical connectors on a personal computer's motherboard.

In servers and other powerful computers multiple memory cards may be connected to the same motherboard. The memory cards may contain solid state memory and may serve as solid state drives. In some systems, for example, the memory cards may be orthogonal to the motherboard, and aligned in parallel along an edge of the motherboard. Such a configuration is described in an industry standard SFF-TA-1016.

Card edge connectors are configured to support this configuration, as they may be mounted to a PCB and mated with an add-in card, such as a memory card. A card edge connector may have a mating interface with a slot sized to receive an edge of the add-in card. Conductors, with a mating contact at one end and a tail at the other end, may pass through a connector from the slot to a mounting interface. At the mounting interface the tails may be attached to the PCB. At the mating interface, the mating contacts may be exposed in the slot, where they can make electrical contacts to pads on an edge of the add-in card inserted into the slot. A conventional card edge connector has two columns of mating contact portions, one on each side of the slot.

### SUMMARY

Aspects of the present disclosure relate to compact high-speed connectors and electronic systems thereof.

Some embodiments relate to an electrical connector. The electrical connector may comprise a first side comprising a first interface elongated in a first column; a second side opposite the first side and comprising: a second interface elongated in a second column parallel to the first column, and a third interface elongated in a third column parallel to the first column; and a third side perpendicular to the first side and second side, the third side comprising a fourth interface elongated in a mating direction perpendicular to the first column.

Optionally, the first, second, and third interfaces are configured to engage with respective interfaces of one or more components; and the fourth interface is configured to mount to a substrate.

Optionally, the electrical connector comprises a first plurality of conductive elements connecting a first portion of the first interface to the fourth interface; and a second plurality of conductive elements connecting a second portion of the first interface to the third interface.

Optionally, the electrical connector comprises a first subassembly comprising: the first plurality of conductive elements extending from the first interface to the fourth interface, and a first subassembly housing holding the first plurality of conductive elements.

Optionally, the electrical connector comprises a second subassembly comprising: a third plurality of conductive elements extending from the second interface to the fourth interface, and a second subassembly housing holding the third plurality of conductive elements.

Optionally, the first subassembly housing and the second subassembly housing are insulative; and the first subassembly and second subassembly are stacked in a third direction perpendicular to both the first column and the mating direction.

Optionally, the electrical connector comprises a pair of first subassemblies, wherein the second subassembly is disposed between the pair of first subassemblies.

Optionally, the electrical connector comprises a third subassembly comprising the second plurality of conductive elements and a third subassembly housing holding the second plurality of conductive elements, wherein the pair of first subassemblies and the third subassembly are disposed in the first column.

Optionally, a distance between the first interface and the second interface is greater than a distance between the first interface and the third interface.

Optionally, the second interface is closer to the fourth interface than the third interface; and the second interface offsets from the third interface in the mating direction.

Optionally, the first interface is configured to receive a card edge; and the second and third interfaces are configured to connect to cables.

Optionally, the first plurality of conductive elements are configured to transmit low-speed signals and/or power; the second plurality of conductive elements are configured to transmit high-speed signals; and the third plurality of conductive elements are configured to transmit low-speed signals and/or power.

Some embodiments relate to an electrical connector. The electrical connector may comprise a housing comprising a first side, a second side opposite the first side, and a third side connecting the first and second sides; a plurality of first conductive elements each comprising a first end disposed at the first side and configured to engage with a respective component, and a second end disposed at the third side and configured to mount to a substrate; a plurality of second conductive elements each comprising a third end disposed at the second side and configured to engage with a respective component, and a fourth end disposed at the third side and configured to mount to a substrate; and a plurality of third conductive elements each comprising a fifth end disposed at the first side, and a sixth end disposed at the second side, each of the fifth and sixth ends configured to engage with respective components.

Optionally, the electrical connector comprises a subassembly housing holding at least a first subset of the plurality of third conductive elements, the subassembly housing comprising a plurality of openings.

Optionally, the electrical connector comprises a first shielding member, wherein: the plurality of third conductive elements comprises the first subset of third conductive elements disposed in a first column and a second subset of third conductive elements disposed in a second column; and the first shielding member is disposed between the first subset and the second subset.

Optionally, the first shielding member comprises a plurality of protrusions configured to extend through the plurality of openings to electrically contact at least one third conductive element of the plurality of third conductive elements.

Optionally, the electrical connector comprises a second shielding member, wherein the first subset is disposed between the first shielding member and the second shielding member.

Optionally, the second shielding member comprises a plurality of extensions extending beyond the subassembly housing in a mating direction perpendicular to the first and second columns.

Optionally, the electrical connector comprises a shield comprising a first shielding member and a second shielding member, wherein the plurality of third conductive elements is disposed between the first shielding member and the second shielding member.

Optionally, the plurality of first conductive elements comprises a first conductor and a plurality of second conductors; and the first end of the first conductor comprises a plurality of mating portions and the second end of the first conductor comprises a plurality of tail portions.

Optionally, an intermediate portion of the first conductor is wider than an intermediate portion of each of the plurality of second conductors.

Optionally, the first conductor is disposed closer to an intersection of the first and third sides than the plurality of second conductors.

Some embodiments relate to an electrical connector. The electrical connector may comprise a first side comprising a first interface, the first interface comprising a first portion and a second portion aligned in a line; a second side opposite the first side and comprising a second interface and a third interface; a third side extending between the first side and the second side, the third side comprising a fourth interface; a first subassembly comprising a first housing holding a plurality of first conductive elements extending from the first portion of the first interface to the fourth interface; a second subassembly comprising a second housing holding a plurality of second conductive elements extending from the second interface to the fourth interface; and a third subassembly comprising a third housing holding a plurality of third conductive elements extending from the second portion of the first interface to the third interface.

Optionally, the third subassembly is separated from the fourth interface by the second subassembly.

Optionally, the electrical connector comprises a pair of first subassemblies, each first subassembly comprising a subset of the plurality of first conductive elements; and a slot between the pair of first subassemblies, wherein the plurality of second conductive elements extend at least partially through the slot to the second interface.

Optionally, the electrical connector comprises an outer housing configured to hold the first subassembly, the second subassembly, and the third subassembly.

Optionally, each of the plurality of first conductive elements comprises a mating end disposed at the first interface and a tail end disposed at the fourth interface, the tail end configured to mount to a first substrate; and each of the plurality of second conductive elements comprises a mating end disposed at the second interface and a tail end disposed at the fourth interface, the tail end configured to mount to the first substrate.

Optionally, the first interface comprises a slot configured to receive a second substrate such that the first and second substrates are electrically connected to each other via the plurality of first conductive elements.

Optionally, the second interface comprises a slot configured to receive a cable connector connected to a third substrate such that the second and third substrates are electrically connected to each other via the plurality of second conductive elements.

Optionally, the electrical connector comprises a latch member disposed adjacent the second interface and configured to secure the cable connector to the second interface.

Some embodiments relate to a cable assembly. The cable assembly may comprise a substrate comprising a first edge, a first plurality of pads disposed along the first edge and elongated in a first direction, a second edge offset from the first edge in the first direction, and a second plurality of pads disposed along the second edge and elongated in the first direction; and a plurality of cables terminated to the substrate.

Optionally, the plurality of cables are connected to the first plurality of pads and the second plurality of pads through the substrate.

Optionally, the cable assembly comprises a housing at least partially holding the substrate, the housing comprising an engagement feature configured for engaging with a latch.

Some embodiments relate to an electronic system. The electronic system may comprise a first substrate, a second substrate, and a third substrate; and an electrical connector comprising a housing; a first interface through the housing disposed on a first side of the electrical connector and electrically connected to the first substrate; a second interface through the housing disposed on a second side of the electrical connector, opposite the first side, and electrically connected to the second substrate; a third interface through the housing disposed on the second side of the electrical connector; and a fourth interface through the housing disposed on a third side of the electrical connector, the third side extending between the first side and the second side, the fourth interface electrically connected to the third substrate.

Optionally, the second substrate is electrically connected to the second interface by a cable assembly having a cable connector, the second interface being configured to receive the cable connector.

Optionally, the second substrate is further electrically connected to the third interface.

Optionally, the electrical connector further comprises a latch pivotably attached to the housing adjacent the third interface, the latch configured to fix the cable connector to the electrical connector when the latch is placed in a latched position.

Optionally, the fourth interface is a mounting interface and the electrical connector is mounted to the third substrate at the mounting interface.

Optionally, the electrical connector is configured to: electrically connect the first substrate with the second and third substrates; and electrically connect the second substrate with the third substrate.

Optionally, the electrical connector is configured to: transmit low-speed signals and/or power from the first interface through first conductive elements mounted to the third substrate and second conductive elements connected to both the cable assembly and the third substrate; and transmit high-speed signals from the first interface through third conductive elements connected to the cable assembly.

Some embodiments relate to an electrical connector. The electrical connecter may comprise a first mating interface, a second mating interface and a third mating interface extending in a longitudinal direction and parallel to each other; and a mounting interface extending in a mating direction perpendicular to the longitudinal direction.

Optionally, the mating direction may include a first mating direction and a second mating direction opposed to each other. A portion of the first mating interface, the second mating interface and the third mating interface may face the first mating direction, and the other portion of the first mating interface, the second mating interface and the third mating interface may face the second mating direction.

Optionally, the first mating interface may face the first mating direction, and the second mating interface and the third mating interface may face the second mating direction.

Optionally, the second mating interface may be closer to the mounting interface than the third mating interface, and the second mating interface may offset from the third mating interface in the second mating direction.

Optionally, a distance from the second mating interface to the first mating interface may be not equal to a distance from the third mating interface to the first mating interface.

Optionally, the electrical connector may further comprises a plurality of first conductive elements, a plurality of second conductive elements and a plurality of second conductive elements. The plurality of first conductive elements may extend from the first mating interface to the mounting interface. The plurality of second conductive elements may extend from the second mating interface to the mounting interface. The plurality of third conductive elements may extend from the first mating interface to the third mating interface.

Optionally, the electrical connector may further comprise: a first subassembly housing holding the plurality of first conductive elements; and a second subassembly housing holding the plurality of second conductive elements. The first subassembly housing and the second subassembly housing may be insulated. The first subassembly housing and the second subassembly housing may be stacked in a transverse direction perpendicular to both the mating direction and the longitudinal direction.

Optionally, the electrical connector may comprise a plurality of the first subassembly housings, and the second subassembly housing may be inserted between the plurality of the first subassembly housings.

Optionally, the plurality of the first subassembly housings may enclose and form a second slot. The plurality of second conductive elements may be bent into the second slot to form the second mating interface.

Optionally, side walls of the second slot may comprise a plurality of second conductive member channels, and the plurality of second conductive elements may pass through the plurality of second conductive member channels correspondingly.

Optionally, the electrical connector may further comprise a front insulating housing. A first slot may be provided on a side of the front insulating housing facing the first mating direction. The plurality of first conductive elements and the plurality of third conductive elements may be bent into the first slot to form the first mating interface. An edge of a whole formed by stacking the first subassembly housing and the second subassembly housing may be inserted into the front insulating housing from a side facing the second mating direction.

Optionally, the electrical connector may further comprise a rear insulating housing. The front insulating housing and the rear insulating housing may be disposed in the mating direction. A third slot may be provided on a side of the rear insulating housing facing the second mating direction. The plurality of third conductive elements may be bent into the third slot to form the third mating interface. The plurality of third conductive elements may be mounted within the front insulating housing and the rear insulating housing.

Optionally, the rear insulating housing may abut against the first subassembly housing in the longitudinal direction.

Optionally, in the second mating direction, the first subassembly housing may extend beyond the rear insulating housing. The first subassembly housing may have a notch on a side facing the rear insulating housing. An end of the rear insulating housing provided with the third mating interface may extend into the notch.

Optionally, the electrical connector may comprise a plurality of the first subassembly housings spaced apart in the transverse direction to form a gap. The rear insulating housing may be engaged to the gap.

Optionally, the plurality of third conductive elements may include differential pairs of signal conductive elements and ground conductive elements dispersed among the differential pairs of signal conductive elements.

Optionally, the electrical connector may further comprise a shield electrically connected to the ground conductive elements. The shield may be disposed on a side of the differential pairs of signal conductive elements in a transverse direction perpendicular to the mating direction and the longitudinal direction.

Optionally, the third conductive elements may be disposed into at least one column parallel to the longitudinal direction. Each of the at least one column may have a corresponding shield. The shield may include an inner shield and an outer shield. For each column, the outer shield, the third conductive elements and the inner shield may be disposed sequentially in the transverse direction toward an inside of the electrical connector.

Optionally, the inner shield may abut against an intermediate portion of each of the ground conductive elements of a corresponding column in an extension direction of the ground conductive elements. The outer shield may abut against each of the ground conductive elements of the corresponding column on two sides of the intermediate portion in the extension direction.

Optionally, the inner shield may have cantilever beams bent toward the ground conductive elements of a corresponding column, and the cantilever beams may abut against the ground conductive elements of the corresponding column.

Optionally, the outer shield may have pleated portions bulging toward the ground conductive elements of a corresponding column, and the pleated portions may abut against the ground conductive elements of the corresponding column.

Optionally, projections may be disposed on surfaces of the pleated portions abutting against the ground conductive elements of the corresponding column.

Optionally, the inner shield may comprise inner shielding extensions protruding toward two ends of the differential pairs of signal conductive elements of a corresponding column and aligned with the differential pairs of signal conductive elements of the corresponding column. The outer shield may comprise outer shielding extensions protruding toward two ends of the differential pairs of signal conductive elements of the corresponding column and aligned with the differential pairs of signal conductive elements of the corresponding column.

Optionally, the inner shielding extension may be shorter than the outer shielding extension in an extension direction of the differential signal conductive elements.

Optionally, the third conductive elements in each of the at least one column may be held by an insulating member. The insulating member may be provided with holes in one-to-one correspondence with the ground conductive elements of a corresponding column.

Optionally, the inner shield and the outer shield may be attached to the insulating member of the corresponding column. The ground conductive elements may have intermediate portions corresponding to the holes and greater than other portions in width.

Optionally, the plurality of first conductive elements may include power conductive elements and side band conductive elements. The plurality of second conductive elements may include side band conductive elements. The plurality of third conductive elements may include high-speed signal conductive elements.

Optionally, the first mating interface may include a first interface segment and a second interface segment disposed in the longitudinal direction. The plurality of first conductive elements may extend from the first interface segment to the mounting interface, and the plurality of third conductive elements may extend from the second interface segment to the third mating interface.

Optionally, the plurality of first conductive elements may have first tail ends extending to the mounting interface and disposed into a first row. The plurality of second conductive elements may have second tail ends extending to the mounting interface and disposed into a second row. The first row and the second row may be parallel to the mating direction. The first row and the second row may be disposed side by side in a transverse direction perpendicular to the mating direction and the longitudinal direction.

Optionally, the first tail ends within the first row and the second tail ends within the second row may be staggered in an extension direction of rows.

Optionally, a center distance between an initial first tail end within the first row adjacent to the first mating interface and an initial second tail end within the second row adjacent to the first mating interface may be less than a center distance between adjacent first tail ends within the first row, so that the first tail ends and the second tail ends are configured for connection to an edge of a substrate.

Some embodiments relate to an electrical connector. The electrical connector may comprise: a first mating interface and a second mating interface opposite each other in a mating direction; a mounting interface extending in the mating direction; a first subassembly held with a plurality of first conductive elements insulated from one another, the plurality of first conductive elements extending from the first mating interface to the mounting interface; and a second subassembly held with a plurality of second conductive elements insulated from one another, the plurality of second conductive elements extending from the second mating interface to the mounting interface. The first subassembly and the second subassembly may be stacked with each other in a transverse direction perpendicular to the mating direction.

Optionally, the first mating interface and the second mating interface may extend in a longitudinal direction perpendicular to the transverse direction and the mating direction.

Optionally, each of the plurality of first conductive elements may include a first mating end and a first tail end at two ends. The first mating ends of the plurality of first conductive elements may be disposed in a first column parallel to a longitudinal direction perpendicular to the transverse direction and the mating direction. Each of the plurality of second conductive elements may include a second mating end and a second tail end at two ends. The second mating ends of the plurality of second conductive elements may be disposed in a second column parallel to the longitudinal direction. The first tail ends of the plurality of first conductive elements may be disposed into a first row, and the second tail ends of the plurality of second conductive elements may be disposed into a second row. The second row and the first row may be parallel to the mating direction. The first row and the second row may be disposed side by side in the transverse direction.

Optionally, the first tail ends within the first row and the second tail ends within the second row may be staggered in an extension direction of rows.

Optionally, a center distance between an initial first tail end within the first row adjacent to the first mating interface and an initial second tail end within the second row adjacent to the first mating interface may be less than a center distance between adjacent first tail ends within the first row, so that the first tail ends and the second tail ends are configured for connection to an edge of a substrate.

Optionally, the electrical connector may comprise a plurality of the first subassemblies, and the second subassembly may be inserted between the plurality of the first subassemblies.

Optionally, the plurality of the first subassemblies may enclose and form a second slot. The plurality of second conductive elements may be bent into the second slot to form the second mating interface.

Optionally, the electrical connector may further comprise a front insulating housing provided with a first slot, the plurality of first conductive elements and the plurality of third conductive elements are bent into the first slot to form the first mating interface. An edge of a whole formed by stacking the first subassemblies and the second subassemblies may be inserted into the front insulating housing from a side opposite the first slot.

Optionally, the electrical connector may further comprise a third mating interface opposite the first mating interface in a mating direction; and a plurality of third conductive elements extending from the first mating interface to the third mating interface.

Optionally, the electrical connector may further comprise a rear insulating housing. The front insulating housing and the rear insulating housing may be disposed in the mating direction. A third slot may be provided on a side of the rear insulating housing back toward the front insulating housing in the mating direction. The plurality of third conductive elements may be mounted within the front insulating housing and the rear insulating housing, and the plurality of third conductive elements may be bent into the third slot to form the third mating interface.

Optionally, the electrical connector may further comprise an outer housing. The front insulating housing, the rear insulating housing, the first subassembly and the second subassembly may be mounted into the outer housing.

Some embodiments relate to an electronic system. The electronic system may comprise a first substrate; a second substrate; a third substrate and an electrical connector. The first substrate, the second substrate and the third substrate may be interconnected by the electrical connector, such that the first substrate is in electrical connection with the second substrate, the second substrate is in electrical connection with the third substrate, and the first substrate is in electrical connection with the third substrate.

Optionally, the electrical connector may comprise a first mating interface, a second mating interface, a third mating interface and a mounting interface. The first mating interface may be disposed opposite the second mating interface and the third mating interface in a mating direction. The first substrate may be connected to the first mating interface. The second substrate may be connected to the second mating interface and the third mating interface. The mounting interface may be parallel to the mating direction, the third substrate connected to the mounting interface.

Optionally, the first mating interface includes a first interface segment and a second interface segment disposed in the longitudinal direction. The first interface segment may be electrically connected to the mounting interface, and the second interface segment may be electrically connected to the third mating interface.

Optionally, the second substrate may be connected to the electrical connector via a cable connector assembly.

Optionally, the electrical connector may be one of the electrical connectors mentioned above.

The techniques described herein may be used alone or in any suitable combination. The foregoing summary is provided by way of illustration and is not intended to be limiting.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a partially exploded side view of an electronic system, according to some embodiments;

FIG. 1B is a top plan view of a portion of the electronic system of FIG. 1A showing electrical connectors mounted in a peripheral region of a substrate with pads along an edge;

FIG. 2A is a front, side perspective view of an electrical connector of the electronic system of FIG. 1A;

FIG. 2B is a rear, side perspective view of the electrical connector of FIG. 2A;

FIG. 3A is a partially exploded view of the electrical connector of FIG. 2A;

FIG. 3B is a front, side perspective view of a first subassembly and a second subassembly of the electrical connector of FIG. 3A assembled together;

FIG. 4 is a side perspective view of the electrical connector of FIG. 2A with an outer housing hidden;

FIG. 5A is a rear, side perspective view of the electrical connector illustrated in FIG. 4;

FIG. 5B is a cross-sectional rear, side perspective view of the electrical connector of FIG. 5A;

FIG. 6 is a schematic view illustrating a method of manufacturing the first subassembly of the electrical connector of FIG. 2A, according to some embodiments;

FIG. 7 is a schematic view illustrating a method of manufacturing of the second subassembly of the electrical connector of FIG. 2A, according to some embodiments;

FIG. 8A is a schematic view illustrating a method of manufacturing of a third subassembly of the electrical connector of FIG. 2A;

FIG. 8B is an exploded view of the third subassembly of FIG. 8A;

FIG. 9 is a perspective view of a third substrate of the electronic system of FIG. 1A;

FIG. 10 is a partially exploded front, side view of the electronic system of FIG. 1A;

FIG. 11 is a rear, side view of the electronic system of FIG. 10;

FIG. 12 is a side view of the electronic system of FIG. 10;

FIG. 13 is an enlarged view of the region of the electronic system of FIG. 10 circled in FIG. 12; and

FIGS. 14-17 are partial enlarged views of the region depicted in FIG. 13 of the electronic system of FIG. 10, with components hidden, respectively.

The above accompanying drawings include the following reference signs:

100, electronic system; 110, 110a, 110b, 110c, 110d, add-in card; 111, first substrate; 120, second substrate; 130, third substrate; 131, peripheral region; 132, 132a, first contact region; 133, 133a, second contact region; 140, first cable connector; 141, first interface; 142, second interface; 143, first cable interface; 144, engagement feature; 150, second cable connector; 151, second cable interface; 152, second cable connector interface; 160, board connector; 200, 200a, 200b, 200c, 200d, electrical connector; 210, first mating interface; 211, first interface segment; 212, second interface segment; 220, second mating interface; 230, third mating interface; 240, mounting interface; 310, first conductive element; 310a, front first conductive element; 311, first mating end; 312, first tail end; 313, power conductive element; 314, conductive element; 320, second conductive element; 320a, front second conductive element; 321, second mating end; 322, second tail end; 330, third conductive element; 331, third mating end; 332, fourth mating end; 333, differential pair of signal conductive elements; 334, ground conductive element; 334a, intermediate portion; 410, first subassembly housing; 411, second slot; 412, second conductive element channel; 413, notch; 414, gap; 420, second subassembly housing; 440, front insulating housing; 441, first slot; 442, first conductive element channel; 450, rear insulating housing; 451, third slot; 452, third conductive element channel; 453, protrusion; 460, first subassembly; 470, second subassembly; 480, third subassembly; 481, insulating member; 482, hole; 500, shield; 510, inner shield; 511, cantilever beam; 512, inner shielding extension; 520, outer shield; 521, pleated portion; 522, projections; 523, outer shielding extension; 610, outer housing; 611, pivot; 620, clamping member; 630, latch; 631, hook; 632, operating portion; 633, pivoting portion.

### DETAILED DESCRIPTION

The Inventors have recognized and appreciated connector designs that enable high performance electronic system architectures while occupying a limited space, enabling components that provide enhanced functionality to be included within the computing system. Such a connector may provide direct interconnections between at least three components, for example, and support hybrid connections, including high-integrity high-speed signal connections, power connections, and/or routing of side band signals.

As electronic systems become more advanced, more data channels and/or processing functionalities may be added. For example, the amount and density of circuits on the electronic system's midplane, backplane, or motherboard may increase. In some embodiments, the midplane, backplane, or motherboard may be constrained in size (e.g., to fit into standardized server cabinets or other package) though the size of add-in cards (e.g., a solid state drive (SSD)) may increase. Examples of such electronic systems may include internet servers and routers which support multiple high data-rate channels. Data transmission rates for each channel in such electronic systems may be up to 10 Gigabit/sec (Gb/s) and beyond. In some cases, data rates may be as high as 150 Gb/s, for example. According to aspects of the present disclosure, connectors are configured to support multiple such high-speed data channels while satisfying physical and/or dimensional constraints of such systems.

Such techniques are illustrated herein with a connector that can provide interconnections between an SSD and a cable connector which is connected to a system board, between the SSD and a mid-plane, and between the mid-plane and the cable connector, which is connected to the system board, respectively, but may be applied in connecting other components.

According to aspects of the present disclosure, an electrical connector may comprise a mounting interface and a plurality of mating interfaces. The mounting interface may be mounted to a substrate. Examples of the substrate may include a mid-plane, a backboard or a motherboard. The plurality of mating interfaces may be in electrical connection with a plurality of substrates. Optionally, the substrates may be connected to the mating interfaces directly, or to the mating interfaces via mating electrical connectors configured to mate with the electrical connector. Optionally, a part of the substrates may be directly connected to a part of the mating interfaces, and the others may be connected to the mating interfaces via mating electrical connectors. The electrical connector may comprise conductive elements. The conductive elements may extend between the interfaces that are configured to connect to each other, thereby forming transmission lanes between the corresponding interfaces.

According to aspects of the present disclosure, a card edge connector connected to a peripheral region of the substrate may be configured to connect several substrates. For example, the several substrates may be orthogonally connected directly to the peripheral region of the substrate via the electrical connectors. Such a configuration may enable a plurality of orthogonal card edge connectors to be disposed side by side along the peripheral region of the substrate, thereby saving space on the substrate and providing scalability for an electronic system. The several substrates, which may be connected directly to the peripheral region of the substrate via the electrical connectors, may include add-in cards, such as SSDs. Additional substrates may be connected, for example, via cable electrical connectors mated with the electrical connector to achieve interconnection with the substrate. Such a configuration may enable these additional substrates to be disposed remotely with respect to the substrate to which the electrical connector is mounted.

According to aspects of the present disclosure, first mating interfaces of the electrical connector may face outward from the substrate to which the connector is mounted. Second and third mating interfaces of the electrical connector may face inward from the substrate to which the connector is mounted. The second and third mating interfaces may be offset from each other in a mating direction. Such a configuration may enable the electrical connector to have a low profile and therefore fit in a limited space.

In some embodiments, the first and third mating interfaces may be directly electrically connected to the mounting interface, while the third mating interfaces may be directly electrically connected to the first mating interfaces. Such a configuration may enable direct interconnections of high speed lanes via the first and third mating interfaces, while power lanes and side band lanes may be directly connected via the mounting interface and the first mating interface, and/or the mounting interface and the third mating face. For example, when the connector is mounted to a mid-plane, such a configuration may eliminate the need of transmitting high speed signals through the mid-plane and therefore improve signal integrity.

In some embodiments, a shield may be provided around the high speed lanes. The shield may be selectively in electrical contact with ground structures in the electrical connector. In some embodiments, the high speed lanes may be configured to include ground conductive elements and differential pairs of signal conductive elements separated by the ground conductive elements. The shield may be selectively in electrical contact with the ground conductive elements. In some embodiments, the shield may include an inner shield and an outer shield are opposite on two sides of the high speed lanes. For each differential pair of signal conductive elements, the inner shield and the outer shield in conjunction with the ground conductive elements may isolate the differential pair of signal conductive elements from an adjacent differential pair of signal conductive elements, forming a shielding frame. As a result, crosstalk can be reduced and high-frequency signal integrity can be improved. Further, corresponding to the differential pairs of signal conductive elements, the shield may have an extended length in the length direction of the conductive elements to enhance shielding effect.

In some embodiments, the conductive elements forming the transmission lanes between two interfaces may have different structures, which may depend on the positions and orientations of the two interfaces which are electrically connected to each other by respective conductive elements. In some embodiments, the conductive elements for forming the transmission lanes between the mating interfaces and the mounting interface may be substantially L-shaped, and the L-shaped conductive elements may have different lengths in the extension direction of the conductive elements. In some embodiments, the conductive elements for forming the transmission lanes between the different mating interfaces may be substantially straight in shape, and the straight conductive elements may have a similar length. The straight conductive elements may be configured as differential pairs of signal conductive elements. Such a configuration may enable the signal conductive elements in each differential pair to have a similar resistance and similar propagation delay.

In some embodiments, the electrical connector may be configured with multiple types of subassemblies. For example, the conductive elements in electrical connection with two interfaces may be formed on the same subassembly. In some embodiments, the electrical connector may comprise a first mating interface, a second mating interface, a third mating interface and a mounting interface. The first mating interface, the second mating interface and the third mating interface may extend in a longitudinal direction and parallel to each other. The mounting interface may extend in a mating direction. A first subassembly may include a plurality of first conductive elements extending from the first mating interface to the mounting interface. A second subassembly may include a plurality of second conductive elements extending from the second mating interface to the mounting interface. A third subassembly may include a plurality of third conductive elements extending from the first mating interface to the third mating interface. In some embodiments, the first conductive elements and the second conductive elements may include side band conductive elements and/or power conductive elements. The third conductive elements may include high-speed signal conductive elements. In some embodiments, the first subassembly and the second subassembly may be stacked with each other in their transverse direction, which is perpendicular to both the longitudinal direction and the mating direction. The third subassembly may be disposed side by side with the stacked first and second subassemblies in the longitudinal direction.

In some embodiments, the electrical connector may comprise insulating housings having a space for receiving the subassemblies. Mating ends of the conductive elements may extend into the space to form the mating interfaces. In some embodiments, the electrical connector may comprise a pair of first subassemblies spaced apart in the transverse direction to form a gap therebetween. The second subassembly may be disposed in the gap. The first subassemblies may enclose and form a slot. Mating ends of the plurality of second conductive elements on the second subassembly may bend into the slot to form the second mating interface.

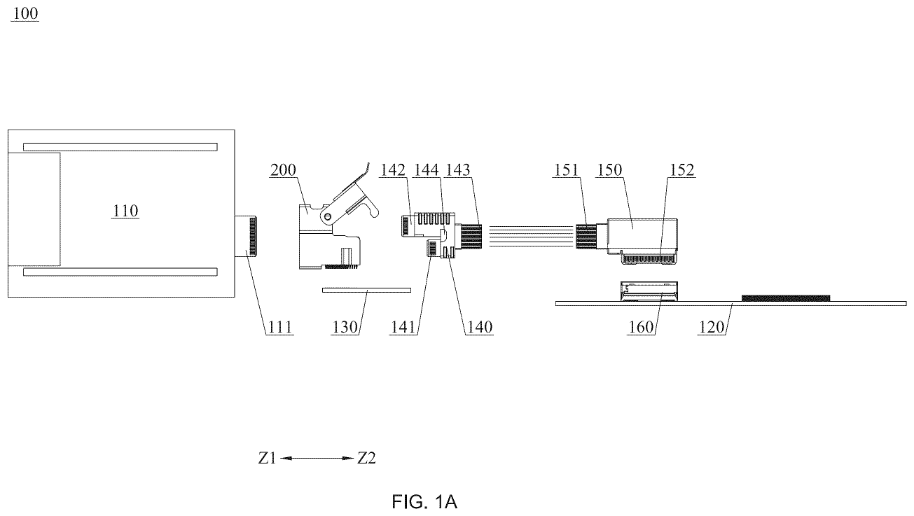

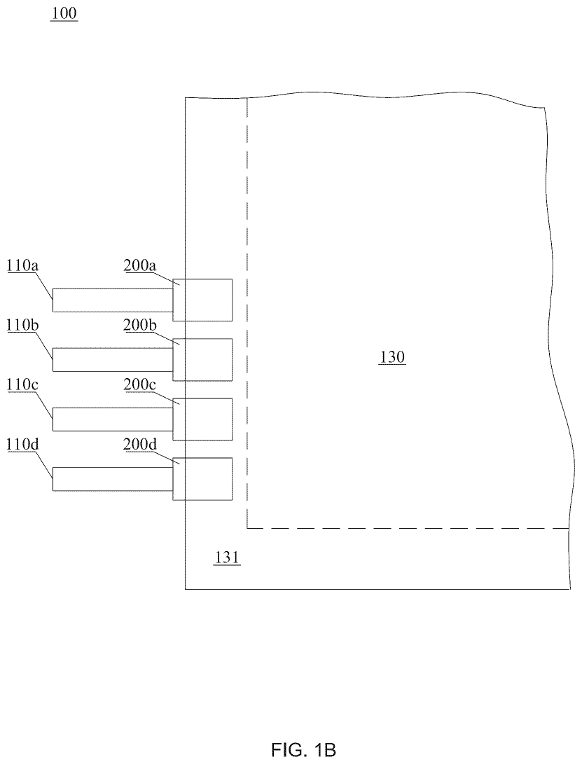

FIG. 1A depicts an exemplary electronic system 100, which may be a part of a data center network device, such as switch, router and server. The electronic system 100 may comprise a first substrate 111, a second substrate 120 and a third substrate 130. The first substrate 111 may be an add-in card. The add-in card 110 may, for example, include one or more of a module card and a non-volatile memory chip. The non-volatile memory chip may be a Solid State Disk (SSD). The second substrate 120 (a portion thereof is shown) may be a motherboard of the data center network device, and may include circuitry and patterned conductors on one or more levels of the substrate. The third substrate 130 (showing a portion thereof) may a mid-plane of the data center network device.

The electronic system 100 may comprise an electrical connector 200 interconnecting the three substrates. The electrical connector 200 may be mounted onto a peripheral region of the third substrate 130. For the configuration illustrated in FIG. 1A, the electrical connector 200 may be referred to as an “orthogonal” electrical connector since the first substrate 111 of the connected add-in card 110 has circuit planes or board surfaces oriented orthogonal to the circuit plane(s) of the third substrate 130. The second substrate 120 may be connected to the electrical connector 200 via a cable connector assembly. The cable connector assembly may include a first cable connector 140 mated to the electrical connector 200, a second cable connector 150 mated to the second substrate 120, and a cable (not shown) connected between the first cable connector 140 and the second cable connector 150. As a result, the second substrate 120 can be disposed remotely with respect to the third substrate 130. The first cable connector 140 and the add-in card 110 may be connected on opposite sides of the electrical connector 200, respectively to avoid mutual interference.

An exemplary electronic system 100 where a plurality of such electrical connectors according to embodiments may be used is depicted in FIG. 1B. The electrical connector 200 in FIG. 1A and the various accompanying drawings described hereinafter may be any one of electrical connectors 200a, 200b, 200c and 200d. It should be noted, however, that the electrical connectors 200a, 200b, 200c and 200d may have different configurations and functions from one another, but the electrical connectors may be similar with respect to the improvements provided by the present disclosure. The electrical connectors 200a, 200b, 200c and 200d may be located along an edge of the third substrate 130 within the edge region 131 thereof. Add-in cards 110a, 110b, 110c and 110d may be connected to sides of the electrical connectors 200a, 200b, 200c and 200d, respectively. The add-in cards 110a, 110b, 110c and 110d may be disposed side-by-side. The opposed sides of the electrical connectors 200a, 200b, 200c and 200d may be connected to corresponding second substrates (not shown) via cable connector assembly, respectively. In some embodiments, the third substrate 130, the add-in cards 110a, 110b, 110c and 110d, the electrical connectors 200a, 200b, 200c and 200d, and the first cable connector (not shown) may be assembled in a support frame or enclosure to fit into one standard unit (1U) of an information technology (IT) equipment rack (approximately 1.75 inches high for a 19-inch-wide or 23-in-wide equipment rack).

In some embodiments, the electrical connector 200 may conform to industry standards or specifications such as the small form factor (SFF) specifications. For example, an electrical connector 200 may receive a card that conforms to the SFF-TA-1007 specification. The specification may specify a number, arrangement, and spacing of contact pads on an add-in card that electrically connect to contacts on the multi-row connector. In some embodiments, the center-to-center spacing between contact pads on the add-in card 110 can be essentially or exactly 0.6 millimeters (mm), though other spacings may be used in other embodiments. For the SFF-TA-1007 specification, there may be between 56 and 84 contact pads (or between approximately those end values) divided between two sides of the add-in card. In some embodiments, there may be more contact pads on the card to which the connector must provide mating ends.

A specification may also specify a spacing between the add-in cards 110a, 110b, 110c and 110d, which may be used for air flow between the cards, according to some embodiments. In some embodiments, there may be fans on the third substrate 130 that move air between the add-in cards 110a, 110b, 110c and 110d. In some embodiments, there may be more than one spacing between the add-in cards that are specified. The fans may be oriented to blow air from right to left or left to right in FIGS. 1A and 1B, for example. The different spacings may be for different levels of power drawn by different add-in cards (e.g., at least 9.5 mm center-to-center spacing for up to 25 watts and at least 18 mm center-to-center spacing for up to 40 watts).

The inventors have further recognized and appreciated that it can be beneficial to make connectors compatible with different types of cards (e.g., versions of add-in cards 110 with fewer or more contact pads that connect to mating ends in the electrical connectors 200 when the cards 120 are plugged into the electrical connectors 200). Additionally, it can be beneficial if the electrical connector's length does not exceed a maximum length (in a direction perpendicular to the edge of the third substrate 130 to which the electrical connector 200 is mounted) of prior versions of the electrical connector, so that the electrical connector 200 can be fasten into a same peripheral region of a third substrate 130 as a prior version of the electrical connector.

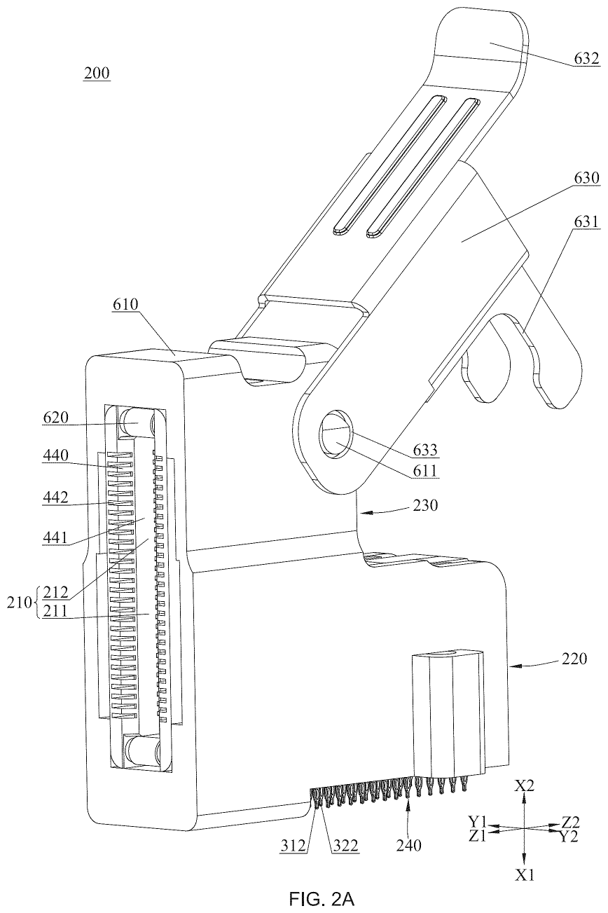

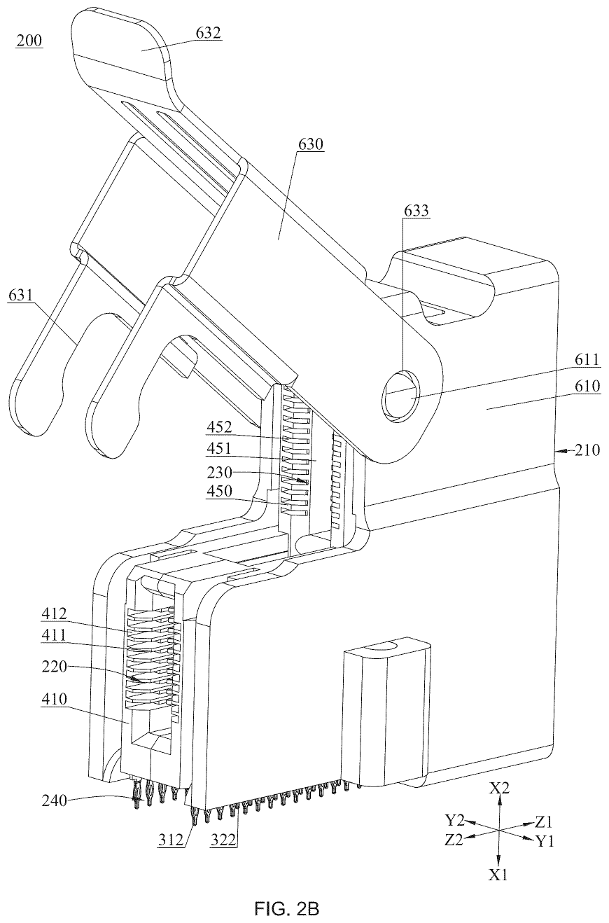

FIGS. 2A-2B show the configuration of the electrical connector 200 provided according to an embodiment of the present disclosure at different angles, respectively. As shown in FIGS. 2A-2B, the electrical connector 200 may include a first mating interface 210, a second mating interface 220, a third mating interface 230 and a mounting interface 240. For clear and concise description, a longitudinal direction X1-X2, a transverse direction Y1-Y2 and a mating direction Z1-Z2 are shown in the drawings. Any two of the longitudinal direction X1-X2, the transverse direction Y1-Y2 and the mating direction Z1-Z2 may be perpendicular to each other. The longitudinal direction X1-X2 may generally refer to a height direction of the electrical connector. The mating direction Z1-Z2 may generally refer to a length direction of the electrical connector. The transverse direction Y1-Y2 may generally refer to a width direction of the electrical connector. The dimension in the width direction may also be referred to as the thickness of the electrical connector 200. The longitudinal direction X1-X2 may include a first longitudinal direction X1 and a second longitudinal direction X2 opposed to each other. The mating direction Z1-Z2 may include a first mating direction Z1 and a second mating direction Z2 opposed to each other.

The first mating interface 210, the second mating interface 220 and the third mating interface 230 may extend in the longitudinal direction X1-X2. For example, the first mating interface 210, the second mating interface 220 and the third mating interface 230 may each be an elongated strip extending in the longitudinal direction X1-X2. It should be noted that the first mating interface 210, the second mating interface 220 and the third mating interface 230 may each be an independent mating interface, rather than three segments of a single mating interface. The first mating interface 210, the second mating interface 220 and the third mating interface 230 may be parallel to each other. Any two of the first mating interface 210, the second mating interface 220 and the third mating interface 230 may not lie on the same plane. The first mating interface 210, the second mating interface 220 and the third mating interface 230 may be used for electrical connection with different circuits, respectively. Optionally, the different circuits may be positioned in different substrates. Optionally, the different circuits may also be positioned in the same substrate. Depending on the architecture of the electronic system, the substrates may be inserted directly into the corresponding mating interfaces or may be connected to the corresponding mating interfaces by means of mated electrical connectors.

The mounting interface 240 may extend in the mating direction Z1-Z2. The mounting interface 240 may be in the form of an elongated strip extending in the mating direction Z1-Z2. The mounting interface 240 may face the third substrate 130 to be mounted, and the third substrate 130 may be perpendicular to the longitudinal direction X1-X2. The mating direction Z1-Z2 is perpendicular to the edge of the third substrate 130 onto which the electrical connector 200 is mounted. The mating direction Z1-Z2 and the longitudinal direction X1-X2 together may define a plane perpendicular to the edge of the third substrate 130 onto which the electrical connector 200 is mounted, the plane being parallel to the add-in card 110. The area of the mounting interface 240 may be positively correlated to the area of a footprint formed by the electrical connector 200 on the third substrate 130. It may be desired that the mounting interface 240 is constrained in perpendicular dimension such that the electrical connector 200 cannot occupy the intermediate region of the third substrate 130 surrounded by the peripheral region 131. The mounting interface 240 may be connected to the third substrate 130 by any suitable means, such as soldering, so that the electrical connector 200 is electrically connected with the third substrate 130.

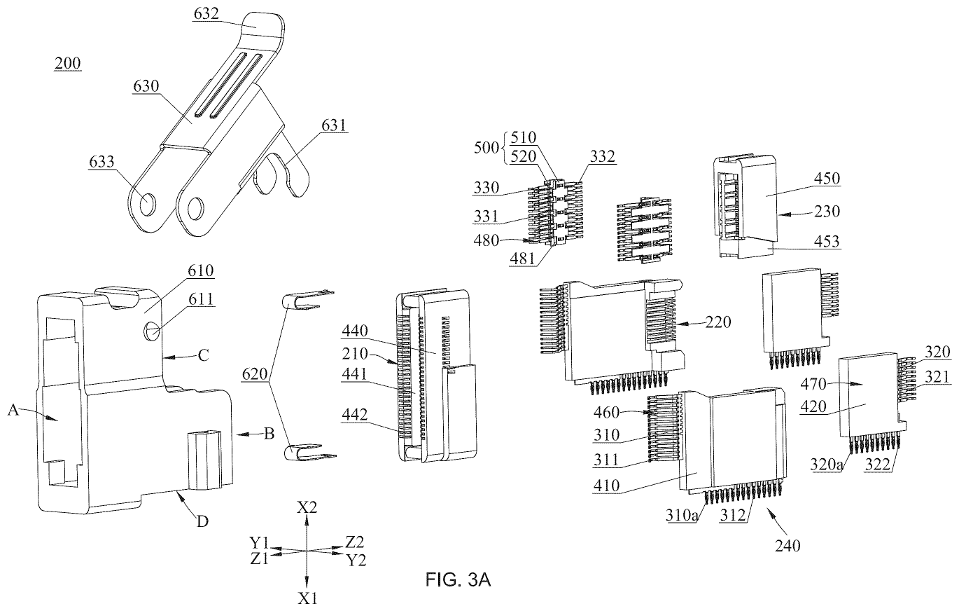

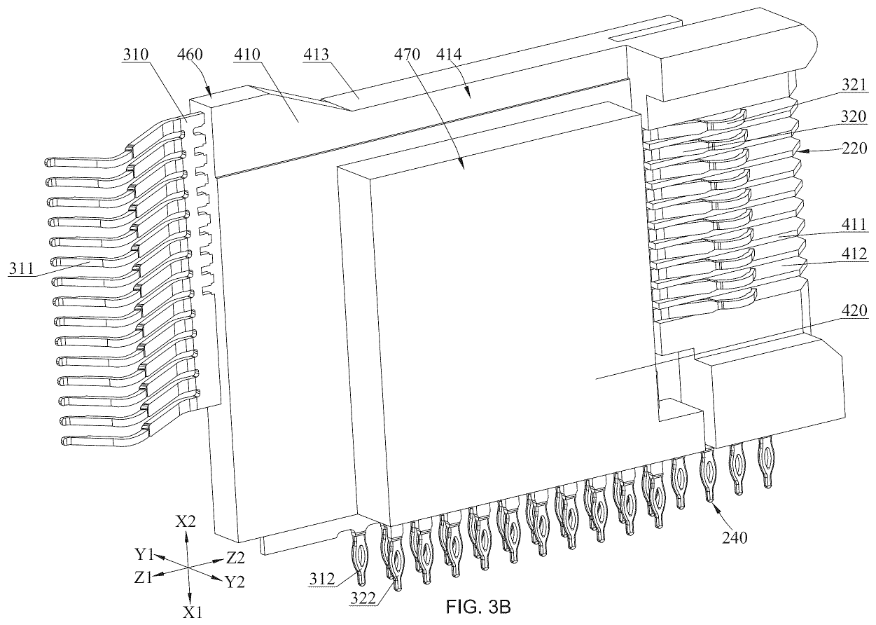

The electrical connector 200 may have an economical design. In some embodiments, the electrical connector 200 may be implemented using subassemblies. Each subassembly may include a plurality of conductive elements. For example, as shown in FIG. 3A, the electrical connector 200 may further include a first subassembly 460, a second subassembly 470 and a third subassembly 480.

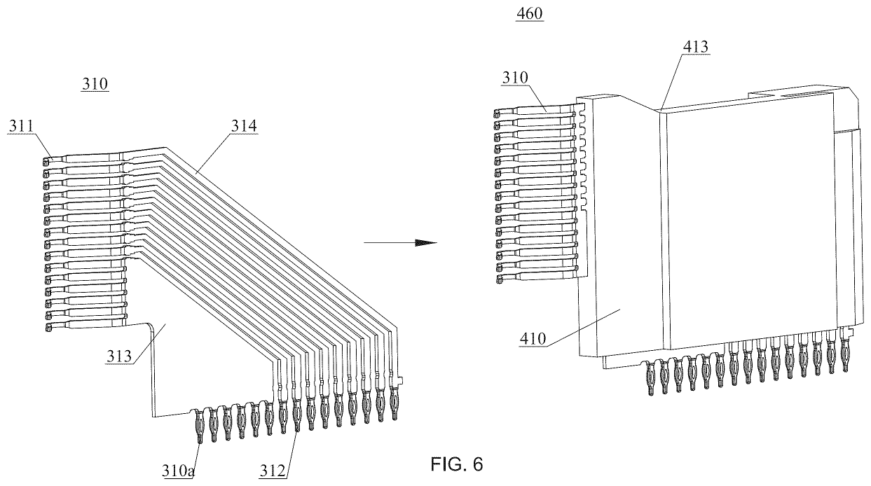

As shown in FIGS. 3A and 6, the first subassembly 460 may hold a plurality of first conductive elements 310. Any two adjacent first conductive elements 310 may be spaced apart to insulate from each other. The first conductive elements 310 may be made of a conductive material such as metal. Each first conductive element 310 may typically be an elongated one-piece member. The plurality of first conductive elements 310 may extend from the first mating interface 210 to the mounting interface 240. In FIG. 3A, the first mating interface, the second mating interface, the third mating interface and the mounting interface are illustrated by 210, 220, 230 and 240 in advance, although these interfaces may be formed after the first subassembly 460, the second subassembly 470 and the third subassembly 480 are mounted onto a front insulating housing 440 and a rear insulating housing 450. A, B, C, and D on an outer housing 610 illustrate respectively the positions of the first mating interface 210, the second mating interface 220, the third mating interface 230 and the mounting interface 240 after the assembly of the three kinds of subassemblies and the two insulating housings as mentioned above onto the outer housing 610. Each first conductive element 310 may include a first mating end 311 and a first tail end 312. The first mating end 311 and the first tail end 312 may be positioned at two ends of the first conductive element 310, respectively. The first mating ends 311 may extend to the first mating interface 210. The first substrate 111 of the add-in card 110 (refer to FIG. 1A) may be connected to the first mating interface 210, for example, the first substrate 111 may be inserted into the first mating interface 210. Contact pads on the first substrate 111 may be in electrical contact with the first mating ends 311 correspondingly. The first tail ends 312 may extend to the mounting interface 240. The first tail ends 312 may be mounted to the third substrate 130 by technologies such as Surface Mounted Technology (SMT) and/or Through-Hole Technology (THT), thereby achieving an electrical connection to the circuits of the third substrate 130. Depending on the mounting technology, the first tail ends 312 may be configured as through-hole pins, SMT tails, or press-mounting tails and so on. Conductive through holes are provided in the third substrate 130. The arrangement pattern of the conductive through holes may correspond to that of the first tail ends 312 of the electrical connector 200 to be connected. The sidewalls of the conductive through holes may be plated with metal conductive layers. The first tail ends 312 may be inserted into corresponding conductive through holes to electrically contact the metal conductive layers. The metal conductive layers of these conductive through holes can be electrically connected to different conductive traces within the third substrate 130 to form the desired circuitry. In this way, the first substrate 111 and the third substrate 130 can be interconnected by the first conductive elements 310.

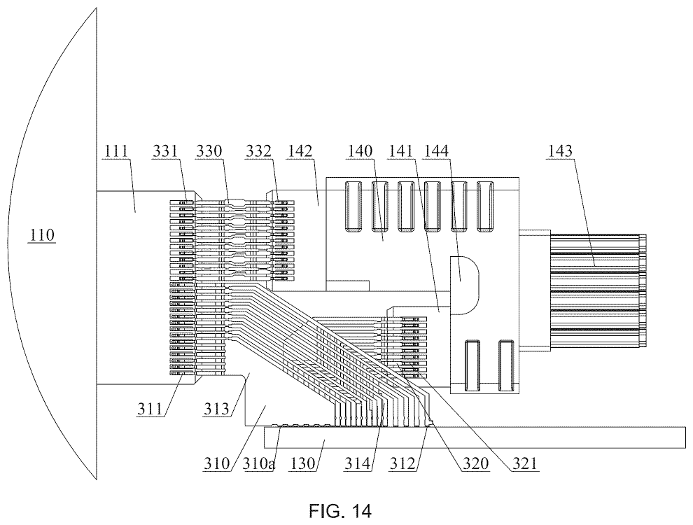

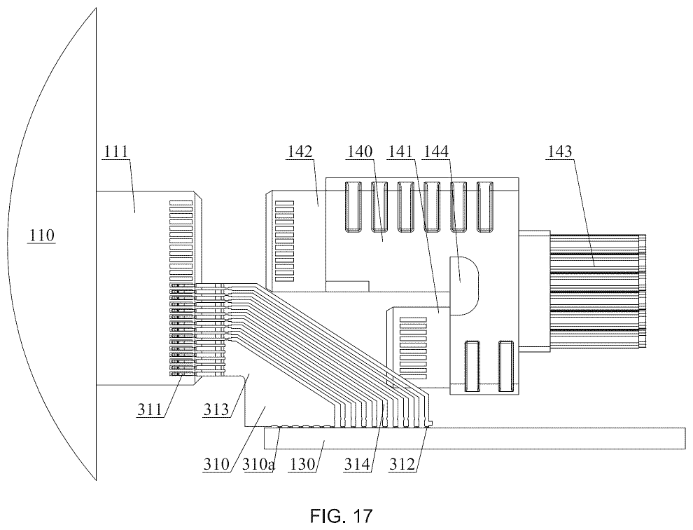

In some embodiments, as shown in FIGS. 6, 14 and 17, the first conductive elements 310 may include power conductive elements 313. In some embodiments, the power conductive elements 313 may have an intermediate portion that is wider than the intermediate portions of the other first conductive elements 310. The power conductive elements 313 may have end portions, one of which may comprise a plurality of first mating ends 311, the other of which may comprise a plurality of first tail ends 312. Further, in some embodiments, the power conductive elements 313 may be disposed in a position closer to a corner of the electrical connector between two adjacent sides of the electrical connector than the other first conductive elements 310, as seen in FIGS. 6, 14, and 17. In some embodiments where the third substrate 130 is served as a mid-plane, the third substrate 130 may typically be connected to a power supply module or a power distribution unit, such that the power conductive elements 313 may be used for transmitting power between the third substrate 130 and the add-in card 110. Optionally, the first conductive elements 310 may include conductive elements 314 for forming side band lanes. The side band lanes refer to communication lanes for transmitting auxiliary information and/or control signals. The side band lanes typically do not directly transmit primary data, but are responsible for additional signals that support and manage data transmission. The control signals may include one or more of control commands, status information, error detection and correction, and the like. The auxiliary information may include one or more of checksums, flow control, clock synchronization, and the like. The auxiliary information may help manage data integrity, reliability and synchronization. Optionally, various configurations and functions of the device may further be managed by the side band lanes. For example, a host system may send management commands to the device via the side band lanes to modify configuration parameters, inquire about device status, identify device information, and the like. As a result, the conductive elements 314 and the paths for signal transmission connected thereto may adaptively adopt materials and/or structures that support only low-speed signals, which may reduce manufacturing costs. In some embodiments, the conductive elements 314 may transmit low-frequency signals (e.g., with a frequency of less than 500 MHz), signals with lower data rates (e.g., less than 100 Mb/s), logic control signals, or any other suitable signal.

The first conductive elements 310 may extend between the first mating interface 210 and the mounting interface 240 perpendicular to each other, and the first conductive elements 310 may be substantially L-shaped. The first conductive elements 310 may be divided into two groups, which may be spaced apart in the transverse direction Y1-Y2. Each group of first conductive elements 310 may be retained together by a first subassembly housing 410 to form the first subassembly 460. The first mating ends 311 of each group of first conductive elements 310 may be disposed in a first column parallel to the longitudinal direction X1-X2. The two columns of first mating ends 311 may be opposite inside the first mating interface 210 and in electrical contact with the contact pads on two sides of the first substrate 111, respectively. The first tail ends 312 of each group of first conductive elements 310 may be disposed in a first row parallel to the mating direction Z1-Z2. Optionally, the first tail ends 312 of the two groups of first conductive elements 310 may be disposed into two rows, which may be substantially aligned in the mating direction Z1-Z2, to prevent the peripheral region 131 of the third substrate 130 from being too wide in dimension. In some embodiments, the first tail ends 312 of the two groups of first conductive elements 310 may be disposed into one row.

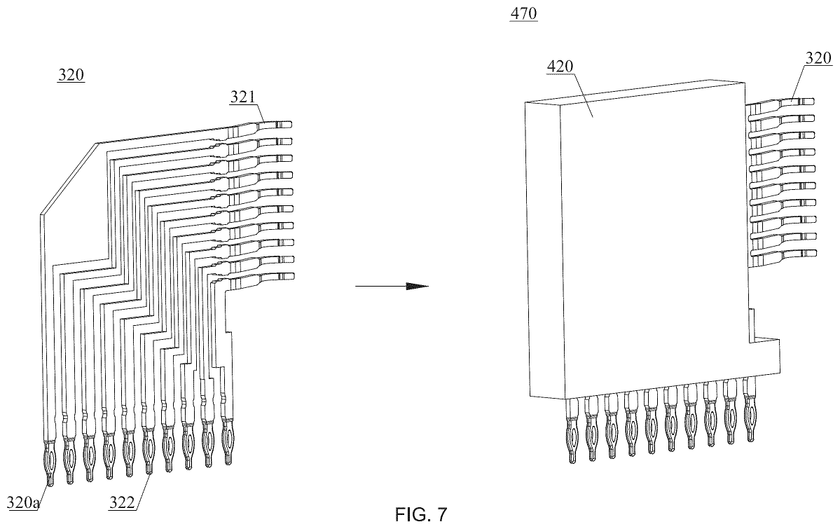

As shown in FIGS. 3A and 7, the second subassembly 470 may be held with a plurality of second conductive elements 320. Any two adjacent second conductive elements 320 may be spaced apart to insulate from each other. The second conductive elements 320 may be made of a conductive material, such as metal. Each second conductive element 320 may typically be an elongated one-piece member. The plurality of second conductive elements 320 may extend from the second mating interface 220 to the mounting interface 240. For example, each second conductive element 320 may include a second mating end 321 and a second tail end 322. The second mating end 321 and the second tail end 322 may be positioned at two ends of the second conductive element 320, respectively. The second mating ends 321 may extend to the second mating interface 220. The first cable connector 140 connected to the second substrate 120 (as shown in FIG. 1A) may be mated with the second mating interface 220. The second tail ends 322 may extend to the mounting interface 240. The second tail ends 322 may be mounted to the third substrate 130 by technologies such as Surface Mounted Technology (SMT) and/or Through-Hole Technology (THT), as shown in FIG. 1A, thereby achieving an electrical connection to the circuits of the third substrate 130. Depending on the mounting technology, the second tail ends 322 may be configured as through-hole pins, SMT tails, or press-mounting tails and so on. Optionally, the third substrate 130 may be provided with conductive through holes. The arrangement pattern of the conductive through holes may correspond to that of the second tail ends 322 of the electrical connector 200 to be connected. Optionally, the sidewalls of the conductive through holes may be plated with metal conductive layers. The second tail ends 322 may be inserted into corresponding conductive through holes to electrically contact the metal conductive layers. The metal conductive layers of these conductive through holes can be electrically connected to different conductive traces within the third substrate 130 to form the desired circuitry. In this way, the second substrate 120 and the third substrate 130 can be interconnected by the second conductive elements 320.

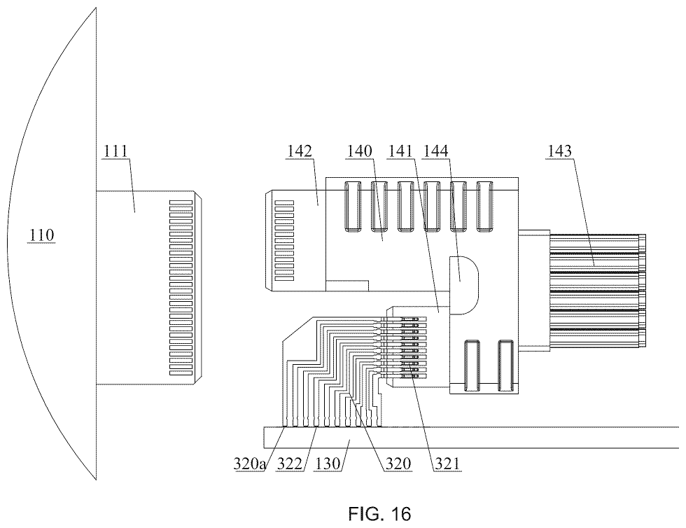

In some embodiments, as shown in FIGS. 7, 14, and 16, the second conductive elements 320 may include conductive elements for forming side band lanes. The role of the side band lanes has been clearly described above and is not repeated herein. The second conductive elements 320 may extend between the second mating interface 220 and the mounting interface 240 perpendicular to each other. The second conductive elements 320 may be substantially L-shaped. The second conductive elements 320 may be divided into two groups, which may be spaced apart in the transverse direction Y1-Y2. Each group of second conductive elements 320 may be retained together by a second subassembly housing 420 to form the second subassembly 470. The second mating ends 321 of each group of second conductive elements 320 may be disposed in a second column parallel to the longitudinal direction X1-X2. The two columns of second mating ends 321 may be opposite inside the second mating interface 220 and in electrical contact with contact pads on two sides of the first cable connector 140, respectively. The second tail ends 322 of each group of second conductive elements 320 may be disposed in a second row parallel to the mating direction Z1-Z2. Optionally, the second tail ends 322 of the two groups of second conductive elements 320 may be disposed into two rows, which may be substantially aligned in the mating direction Z1-Z2, to prevent the peripheral region 131 of the third substrate 130 from being too wide in dimension. In some embodiments, the second tail ends 322 of the two groups of second conductive elements 320 may be disposed into one row.

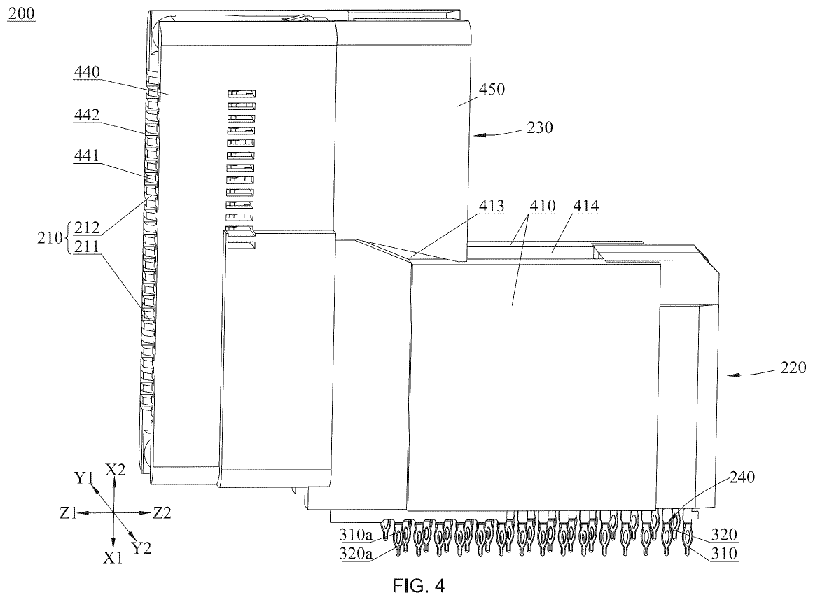

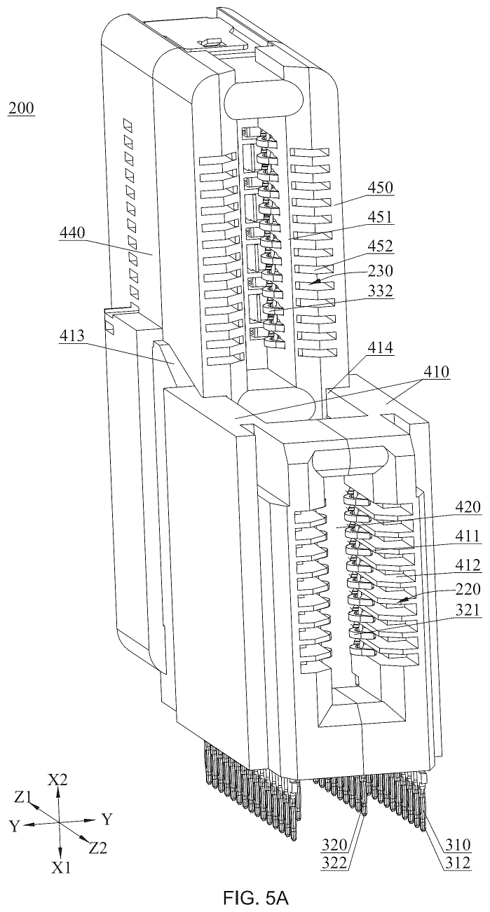

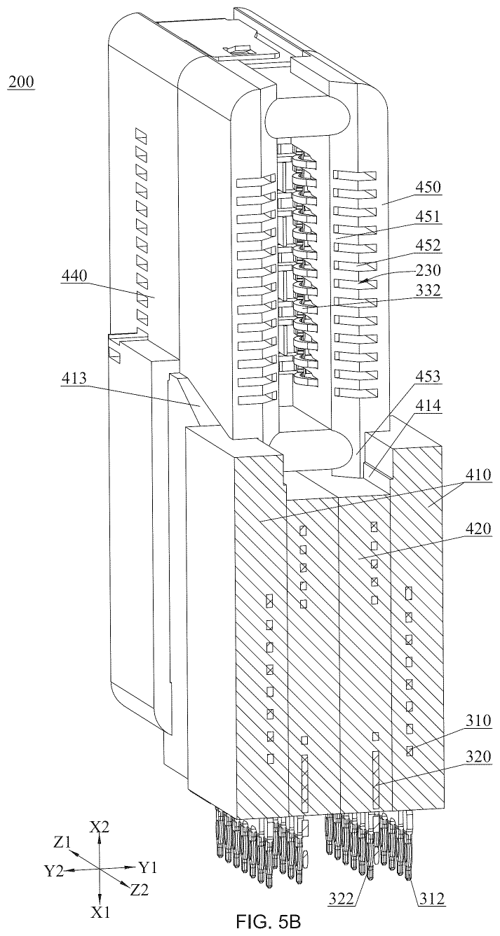

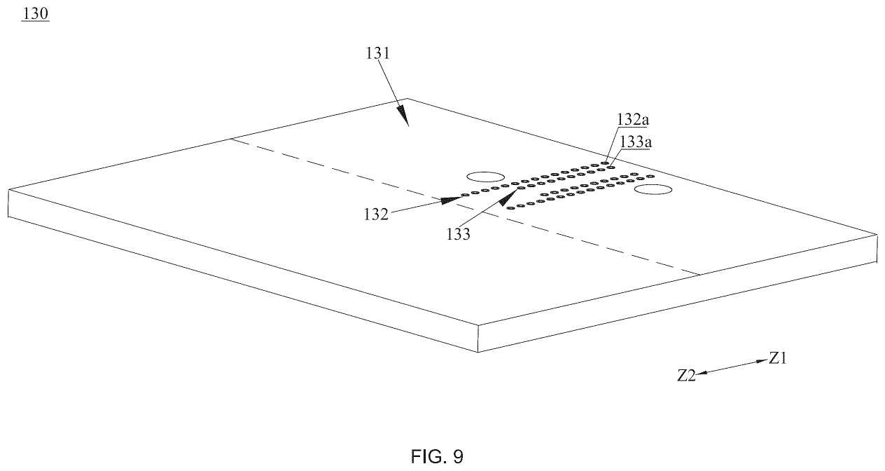

In some embodiments, as shown in FIGS. 4 and 5A-5B, the first row of the first tail ends 312 and the second row of the second tail ends 322 may be parallel to the mating direction Z1-Z2. The first row and the second row may be disposed side by side in the transverse direction Y1-Y2. Thus, a perpendicular dimension of the mounting interface 240 may be determined by the longer one from the first and second rows. This may not result in a significant increase in a perpendicular dimension of the footprint occupied by the improved electrical connector 200 at the peripheral region 131 of the third substrate 130. In the illustrated embodiment, the first tail ends 312 in the first row is greater than the second tail ends 322 in the second row in number, so that the length of the first row is greater than the length of the second row, and the perpendicular dimension of the mounting interface 240 is determined by the length of the first row. In the illustrated embodiment, the second subassembly 470 is disposed between the first subassemblies 460. As shown in FIGS. 4 and 5A-5B, the first tail ends 312 in the first row are adjacent to the second tail ends 322 in the second row, and the adjacent two rows are staggered in the extension direction of the rows (i.e., the mating direction Z1-Z2). Thus, as shown in FIG. 9, first contact regions 132 for receiving the first tail ends 312 and second contact regions 133 for receiving the second tail ends 322 in the third substrate 130 may have a larger center distance. In this way, even if the first contact regions 132 and the second contact regions 133 have relatively larger diameters, relatively larger gaps are left between adjacent contact regions. In other embodiments where the first tail ends 312 and the second tail ends 322 are connected to the third substrate 130 by other means, the increased gaps between adjacent tail ends may also be advantageous for connection of the electrical connector 200 to the third substrate 130.

In some embodiments, as shown in FIGS. 4 and 6-7, the plurality of first conductive elements 310 may include an front first conductive element 310a. The front first conductive element 310a may be adjacent to the first mating interface 210. The plurality of second conductive elements 320 may include an front second conductive element 320a. The front second conductive element 320a may be adjacent to the first mating interface 210. The front first conductive element 310a may be inserted into an initial first contact region 132a (shown in FIG. 9) of the first contact regions 132. The front second conductive element 320a may be inserted into an initial second contact region 133a (as shown in FIG. 9) of the second contact regions 133. A center distance between the front first conductive element 310a and the front second conductive element 320a may be less than a center distance between adjacent first tail ends 312 within the first row. The center distance between adjacent first tail ends 312 within the first row is substantially the same as a center distance between adjacent second tail ends 322 within the second row. By starting both the first row of the first tail ends 312 and the second row of the second tail ends 322 from positions close to the first mating interface 210, the first tail ends 312 and the second tail ends 322 can be connected to the peripheral region 131 of the third substrate 130, so that a sufficient space is available for layout within the third substrate 130. In some embodiments, the front first conductive element 310a and the front second conductive element 320a may be unaligned such that the first row of the first tail ends 312 may be staggered as a whole relative to the second row of the second tail ends 322 in the extension direction of the rows (i.e., the mating direction Z1-Z2). In other embodiments, the front first conductive element 310a and the front second conductive element 320a may be aligned in the extension direction of the rows.

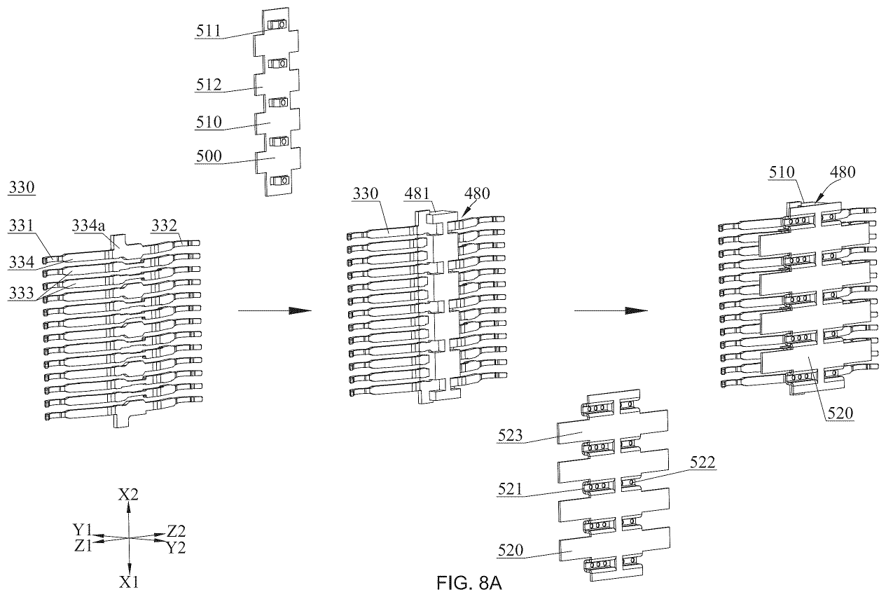

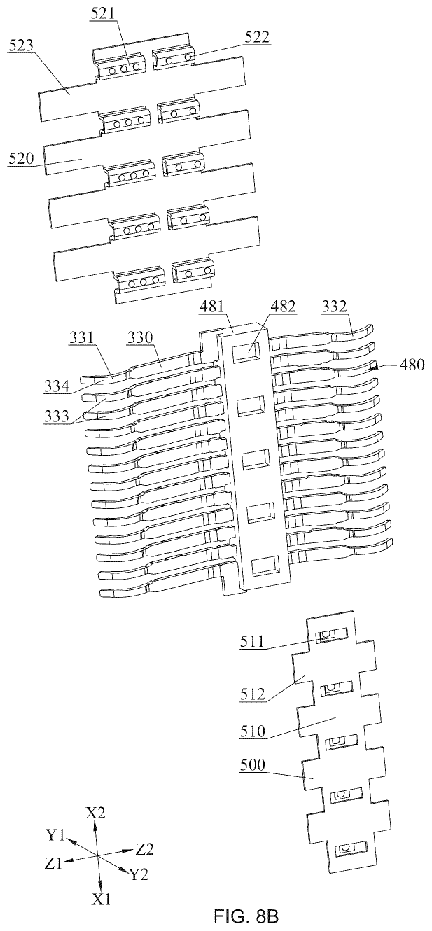

As shown in FIGS. 3A and 8A-8B, the third subassembly 480 may be held with a plurality of third conductive elements 330. Any two adjacent third conductive elements 330 may be spaced apart to insulate from each other. The third conductive elements 330 may be made of a conductive material such as metal. Each third conductive element 330 may typically be an elongated one-piece member. The plurality of third conductive elements 330 may extend from the first mating interface 210 to the third mating interface 230. For example, each third conductive element 330 may include a third mating end 331 and a fourth mating end 332. The third mating end 331 and the fourth mating end 332 may be positioned at two ends of the third conductive element 330, respectively. The third mating ends 331 may extend to the first mating interface 210. The third mating ends 331 are in electrical contact with corresponding contact pads on the first substrate 111. The fourth mating ends 332 may extend to the third mating interface 230. The second substrate 120 may also be connected to the third mating interface 230 via a cable connector assembly. In this way, the third conductive elements 330 may transmit high-speed data and/or high-frequency signals directly between the second substrate 120 and the first substrate 111 without passing through the third substrate 130. In this way, the first substrate 111 and the second substrate 120 can be interconnected directly by the third conductive elements 330. The add-in card 110 may be a storage module, such as SSD, which use a flash memory chip rather than a conventional mechanical disk, and therefore have high data access speed and response performance. This makes them ideal for applications that require fast reading and writing of data, such as operating systems, applications, multimedia files, and the like. It may quickly transfer data, and communicate with computer systems or other devices through various interfaces and protocols, such as SATA, PCIe, and the like. The plurality of third conductive elements 330 may include high-speed signal conductive elements, for example, differential signal pairs. The differential signal pairs may be configured to carry high data-rate signals (e.g., signals carrying data rates over 25 Gb/sec with PAM4 encoding) or high-frequency signals (e.g., over 56 or 112 Gb/sec), according to some implementations. The high-speed data transmission between the second substrate 120, as a motherboard of the system, and the add-in card 110, such as an SSD, may improve signal integrity and provide high data access speed and system response performance.

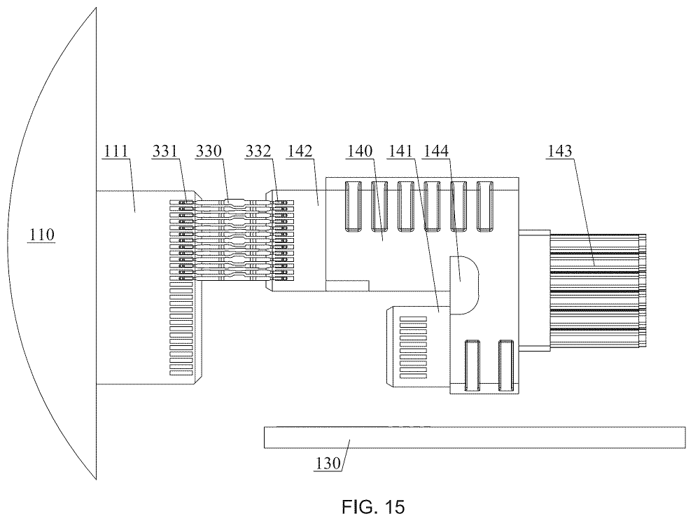

In some embodiments, the first mating interface 210 and the third mating interface 230 may be opposite each other in the mating direction Z1-Z2, and the third conductive elements 330 may extend between the first mating interface 210 and the third mating interface 230 along a substantially straight line, as shown in FIG. 15. The third conductive elements 330 may have approximately the same length. Thus, in transmission of high-speed data and/or high-frequency signals using a plurality of differential pairs of signal conductive elements, there may be reduced imbalance of electrical properties within each differential pair and between the differential pairs. The imbalance may cause delays in a longer conductive element relative to a shorter conductive element. The plurality of third conductive elements 330 may be divided into two groups, which may be spaced apart in the transverse direction Y1-Y2. In some embodiments, each group of third conductive elements 330 may be disposed in the longitudinal direction X1-X2. Each group of third conductive elements 330 may be retained together by an insulating member 481 to form the third subassembly 480. The third mating ends 331 of each group of third conductive elements 330 may be lined up with the first mating ends 311 of the first conductive elements 310 in the first column. The two columns of third mating ends 331 may be opposite inside the first mating interface 210 and in electrical contact with the contact pads on two sides of the first substrate 111, respectively. The fourth mating ends 332 of each group of third conductive elements 330 may be disposed in a third column, the third column being parallel to the first column. The two columns of fourth mating ends 332 may be opposite inside the third mating interface 230 and are in electrical contact with the contact pads on the cable connector, respectively. Optionally, the two groups of third conductive elements 330 may be aligned with each other in the longitudinal direction X1-X2. Optionally, the two groups of third conductive elements 330 may be staggered in the longitudinal direction X1-X2 to increase the interval between the third conductive elements 330, thereby reducing crosstalk. In some embodiments, only one group of third conductive elements 330 may be provided.

In some embodiments, as shown in FIGS. 2A and 4, the first mating interface 210 may include a first interface segment 211 and a second interface segment 212. The first interface segment 211 and the second interface segment 212 may be disposed in the longitudinal direction X1-X2. The first interface segment 211 may be electrically connected to the mounting interface 240, and the second interface segment 212 may be electrically connected to a third mating interface 230. In this way, the first mating ends 311 of the first conductive elements 310 may extend to the first interface segment 211. The third mating ends 331 of the third conductive elements 320 may extend to the second interface segment 212. Independent circuits in the first substrate 111 may be connected to the first interface segment 211 and the second interface segment 212, respectively. Although the first mating interface 210 is divided into two segments, there may no clear demarcation in appearance. In some embodiments, a dividing rib inside the first mating interface 210 may be provided so that the first interface segment 211 and the second interface segment 212 can be clearly distinguished from each other. In this case, it may be beneficial to provide a notch in the portion of the first substrate 111 that is inserted into the first mating interface 210 to accommodate the dividing rib. Alternatively, it may be possible to space apart the first interface segment 211 from the second interface segment 212 in the longitudinal direction X1-X2, in order to be visually distinguishable. In some embodiments, the first interface segment 211 and the second interface segment 212 may be configured to mate with the portion of the first substrate 111 inserted into the first mating interface 210.

In some embodiments, the second substrate 120 may be directly connected to the second mating interface 220 and the third mating interface 230. Additionally or alternatively, as show in FIG. 1A, the second substrate 120 may be connected to the electrical connector 200 via a cable connector assembly. For example, the cable connector assembly may include the first cable connector 140, the second cable connector 150, the cable (not shown) connected between the first cable connector 140 and the second cable connector 150, and a board connector 160. The first cable connector 140 may include a first interface 141, a second interface 142 and a first cable interface 143. The first interface 141 may be connected to the second mating interface 220. The second interface 142 may be connected to the third mating interface 230. The first cable interface 143 may be electrically connected to the first interface 141 and the second interface 142. The second cable connector 150 may include a second cable interface 151 and a second cable connector interface 152. The second cable interface 151 may be electrically connected to the first cable interface 143 via a cable. The second cable connector interface 152 may be connected to the board connector 160. The board connector 160 may be fixed and electrically connected to the second substrate 120. With this configuration, the second substrate 120 achieves remote connection to the electrical connector 200. Depending on the structure of the first cable connector 140, the second mating interface 220 and the third mating interface 230 may be spaced apart in the mating direction Z1-Z2.

The electrical connector 200 as described herein may be connected with at least three substrates at the same time, by means of the first mating interface 210, the second mating interface 220, the third mating interface 230, and the mounting interface 240, thereby achieving interconnection of a plurality of substrates. As shown in FIG. 1A, when the electrical connector 200 is applied to the electronic system 100, the number of electrical connectors of the electronic system 100 may be reduced, and the space utilization of the electronic system 100 may be increased.

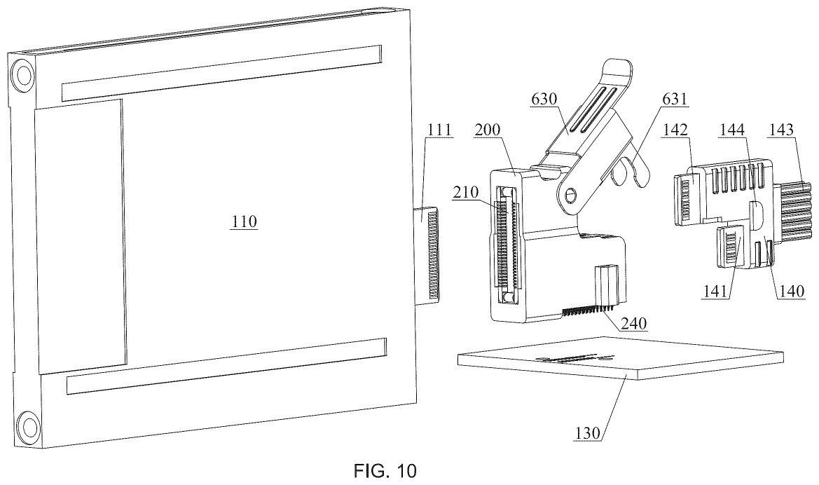

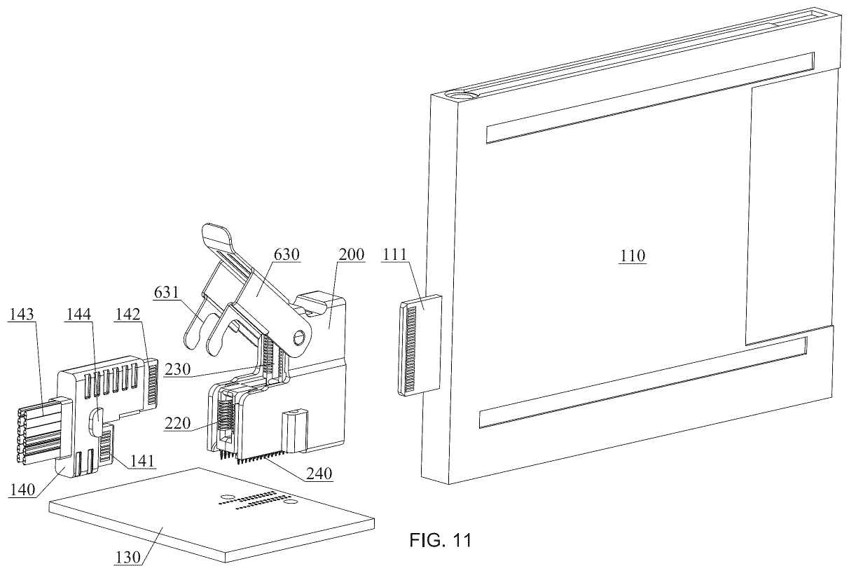

As shown in FIGS. 2A-2B, a portion of the first mating interface 210, the second mating interface 220 and the third mating interface 230 may be oriented toward a first mating direction Z1, and the other portion thereof may be oriented toward a second mating direction Z2. Thus, a longitudinal height of the electrical connector 200 may be reduced. Moreover, the first substrate 111 and the second substrate 120 may be disposed on two sides of the electrical connector 200 opposed each other in the mating direction Z1-Z2, respectively, without a centralized arrangement on a same side, such that the electronic system 100 may be assembled in a support frame or enclosure to fit into one standard unit (1U) of an information technology (IT) equipment rack. In some embodiments, the first mating interface 210 may face the first mating direction Z1. The second mating interface 220 and the third mating interface 230 may face the second mating direction Z2. In this way, the second mating interface 220 and the third mating interface 230 may be connected to the first interface 141 and the second interface 142 of the first cable connector 140, respectively. In this way, the first cable connector 140 can be connected to both the second mating interface 220 and the third mating interface 230. In some embodiments, the second mating interface 220 and the third mating interface 230 may be disposed in the longitudinal direction X1-X2. In some embodiments, as shown in FIG. 1A and FIGS. 10-11, the second mating interface 220 as compared to the third mating interface 230 may be closer to the mounting interface 240. Since the second conductive elements 320 extend from the second mating interface 220 to the mounting interface 240, the length of the second conductive elements 320 is relatively shorter, so that the dimension of the second subassembly 470 holding the second conductive elements 320 may be much smaller, thereby allowing the electrical connector 200 to have a smaller dimension.

In some embodiments, a distance from the second mating interface 220 to the first mating interface 210 may not be equal to a distance from the third mating interface 230 to the first mating interface 210. In some embodiments, the second mating interface 220 may offset from the third mating interface 230 in the second mating direction Z2. Alternatively or additionally, the third mating interface 230 may offset from the second mating interface 220 in the second mating direction Z2. The second mating interface 220 and the third mating interface 230 may be disposed in different planes, respectively. For example, the third mating interface 230 may be disposed between the second mating interface 220 and the first mating interface 210. In this way, in addition to being configured to the structure of the first cable connector 140, the longitudinal height of the electrical connector 200 may be further reduced. The mating interfaces typically include the mating ends of the conductive elements and the insulator enclosing the mating ends. To allow for sufficient mechanical strength, the insulator may have sufficient thickness, which causes the mating interfaces to be larger in dimension. Providing the second mating interface 220 and the third mating interface 230 on different planes may enable the second mating interface 220 and the third mating interface 230 to have overlapping regions in the longitudinal direction X1-X2. The third mating interface 230 may extend into the corresponding portion of the second mating interface 220, thereby reducing the longitudinal height of the electrical connector 200. In addition, the electrical connector 200 may further have a dummy-proof property to prevent from misconnections. In some embodiments, the second mating interface 220 may offset from the third mating interface 230 in the second mating direction Z2. Since the second conductive elements 320 extending between the second mating interface 220 and the mounting interface 240 are L-shaped, the second conductive elements 320 may have the portions disposed in the mating direction Z1-Z2, which results in a larger perpendicular dimension of the second subassembly 470. The plurality of first conductive elements 310 are also L-shaped, which results in a larger perpendicular dimension of the first subassembly 460 as well. In some embodiments, having the first subassemblies 460 and the second subassemblies 470 stacked together may improve the space utilization of the electrical connector 200. The third conductive elements 330 may be shorter so that a perpendicular dimension of the portion between the first mating interface 210 and the second mating interface 220 may be larger than a perpendicular dimension of the portion between the first mating interface 210 and the third mating interface 230 to allow for the considerations discussed above.

As shown in FIGS. 3A, 6-7 and FIGS. 8A-8B, the plurality of first conductive elements 310 may be held by the first subassembly housing 410 to form the first subassembly 460. The plurality of second conductive elements 320 may be held by the second subassembly housing 420 to form the second subassembly 470. The plurality of third conductive elements 330 may be held by the insulating member 481 to form the third subassembly 480.

In some embodiments, the first subassembly housings 410, the second subassembly housings 420 and the insulating member 481 may be insulative. The first subassembly housings 410, the second subassembly housings 420 and/or the insulating member 481 may be molded with an insulative material, such as plastic. Various types of plastics may be used such as, but not limited to, liquid crystal polymers (LCP), polyphenylene sulfite (PPS), high-temperature nylon or poly-p-phenylene oxide (PPO), or polypropylene (PP). In some embodiments, the plastic may be a thermoset plastic. In some embodiments, the insulative plastic may include insulative reinforcing material such as glass fibers. The first subassembly 460, the second subassembly 470, and the third subassembly 480 may be fabricated using a similar process. The process is described below by taking the first subassembly 460 as an example. Although the plurality of first conductive elements 310 illustrated on the left in FIG. 6 are separated to insulate each other, they may be joined to form an integral member before the first subassembly housing 410 is molded onto the plurality of first conductive elements 310. In some embodiments, the plurality of first conductive elements 310 on the left in FIG. 6 may have their edges joined together at the periphery of these first conductive elements 310 by a lead frame (not shown) before the first subassembly housing 410 is molded, such that the plurality of first conductive elements 310 are integral. The lead frame may be made of the same material as the plurality of first conductive elements 310. In some embodiments, the integral member may be stamped or cut by a metal sheet. The metal for the integral member may include, but is not limited to, copper or copper alloys such as phosphor bronze, chrome-plated copper, or beryllium copper, or aluminum, chrome-plated aluminum, aluminum alloys, and the like. In some embodiments, the first subassembly housing 410 is then molded onto suitable portions of this integral member by an injection molding process. During or after the molding process, the lead frame may be cut and/or removed so that the plurality of first conductive elements 310 can be electrically insulated from one another. Thus, the first subassembly housing 410 may serve to support and hold the first conductive elements 310, and make the first conductive elements 310 electrically insulated from one another.

In some embodiments, the number of first subassembly housings 410 may be the same as the row number of first conductive elements 310. Each first subassembly housing 410 may hold one row of first conductive elements 310. In some embodiments, the number of second subassembly housings 420 may be the same as the row number of second conductive elements 320. Each second subassembly housing 420 may hold one row of second conductive elements 320. The first subassembly housings 410 and the second subassembly housings 420 may be stacked in the transverse direction Y1-Y2. For example, as shown in FIGS. 3B and 5A-5B, there are two first subassembly housings 410. The second subassembly housings 420 may be inserted between the first subassembly housings 410. A gap 414 may be provided between the first subassembly housings 410, and the gap 414 may penetrate through the first subassembly housings 410 in the longitudinal direction X1-X2. The second subassembly housings 420 may be disposed within the gap 414. In the transverse direction Y1-Y2, the first subassembly housings 410 may be closer to the outer sides of the electrical connector 200, and the second subassembly housings 420 may be closer to the inner sides of the electrical connector 200. In this way, the first subassembly housings 410 may serve to position the second subassembly housings 420.

In some embodiments, as shown in FIGS. 5A-5B, the plurality of first subassembly housings 410 may enclose and form a second slot 411. The second slot 411 may extend in the longitudinal direction X1-X2. The plurality of second conductive elements 320 may be bent into the second slot 411. For example, the second mating ends 321 of the plurality of second conductive elements 320 may be bent into the second slot 411 to form the second mating interface 220. In this way, the first interface 141 of the first cable connector 140 may be a plug. The first interface 141 may be inserted into the second mating interface 220 so that it may be electrically connected to the second mating ends 321.

In some embodiments, as shown in FIGS. 5A-5B, side walls of the second slot 411 may include a plurality of second conductive element channels 412. The plurality of second conductive elements 320 may pass through the plurality of second conductive element channels 412 in one-to-one correspondence. The second conductive element channels 412 may serve to position the second mating ends 321 of the second conductive elements 320, such that the second conductive elements 320 can be limited at desired positions to be electrically insulated from one another.

In some embodiments, as shown in FIGS. 3A, 4 and 5A-5B, the electrical connector 200 may comprise a front insulating housing 440. The front insulating housing 440 may be molded with an insulative material, such as plastic. Various types of plastics may be used such as, but not limited to, liquid crystal polymers (LCP), polyphenylene sulfite (PPS), high-temperature nylon or poly-p-phenylene oxide (PPO), or polypropylene (PP). In some embodiments, the plastic may be a thermoset plastic. In some embodiments, the insulative plastic may include insulative reinforcing material such as glass fibers. The front insulating housing 440 may generally be a one-piece member. A first slot 441 may be provided on a side of the front insulating housing 440 facing the first mating direction Z1. The plurality of first conductive elements 310 and the plurality of third conductive elements 330 may be bent into the first slot 441. For example, the first mating ends 311 of the plurality of first conductive elements 310 and the third mating ends 331 of the plurality of third conductive elements 330 may be bent into the first slot 441 to form the first mating interface 210. The first substrate 111 may be inserted into the first mating interface 210, and thus be electrically connected to the first mating ends 311 and the third mating ends 331.

An edge of a whole formed by stacking the first subassembly housings 410 and the second subassembly housings 420 may be inserted into the front insulating housing 440 from the side facing the second mating direction Z2. In this way, the first subassembly housings 410 and the second subassembly housings 420 may be relatively fixed by the front insulating housing 440.

In some embodiments, as shown in FIG. 4, side walls of the first slot 441 may include a plurality of first conductive element channels 442. The plurality of first conductive elements 310 and the plurality of third conductive elements 330 may pass through the plurality of first conductive element channels 442 in one-to-one correspondence. The first conductive element channels 442 may serve to position the first mating ends 311 of the first conductive elements 310 and the third mating ends 331 of the third conductive elements 330, such that the first conductive elements 310 and the third conductive elements 330 can be limited at desired positions to be electrically insulated from one another.

In some embodiments, as shown in FIGS. 3A, 4 and 5A-5B, the electrical connector 200 may comprise a rear insulating housing 450. The rear insulating housing 450 may be molded with an insulative material, such as plastic. Various types of plastics may be used such as, but not limited to, liquid crystal polymers (LCP), polyphenylene sulfite (PPS), high-temperature nylon or poly-p-phenylene oxide (PPO), or polypropylene (PP). In some embodiments, the plastic may be a thermoset plastic. In some embodiments, the insulative plastic may include insulative reinforcing material such as glass fibers. The rear insulating housing 450 may generally be a one-piece member. The front insulating housing 440 and the rear insulating housing 450 may be disposed in the mating direction Z1-Z2. A third slot 451 may be provided on a side of the rear insulating housing 450 facing the second mating direction Z2. The plurality of third conductive elements 330 may be bent into the third slot 451. For example, the fourth mating ends 332 of the plurality of third conductive elements 330 may be bent into the third slot 451 to form the third mating interface 230. In this way, the second interface 142 of the first cable connector 140 may be a plug. The second interface 142 may be inserted into the third mating interface 230, thus be electrically connected to the fourth mating ends 332. The plurality of third conductive elements 330 may be mounted within the front insulating housing 440 and the rear insulating housing 450.

In some embodiments, as shown in FIGS. 5A-5B, side walls of the third slot 451 may include a plurality of third conductive element channels 452. The plurality of third conductive elements 330 may pass through the plurality of third conductive element channels 452 in a one-to-one correspondence. The third conductive element channels 452 may serve to position the fourth mating ends 332 of the third conductive elements 330, such that the third conductive elements 330 can be limited at desired positions to be electrically insulated from one another.

In some embodiments, as shown in FIGS. 3A, 4 and 5A-5B, the rear insulating housing 450 may abut against the first subassembly housing 410 in the longitudinal direction X1-X2. The rear insulating housing may comprise a protrusion 453 on a side abutting against the first subassembly housing 410. The protrusion 453 may be inserted into the gap 414 between the first subassembly housings 410. The rear insulating housing 450 may abut against the front insulating housing 440 in the mating direction Z1-Z2. In addition to being positioned by abutment, both the rear insulating housing 450 and the front insulating housing 440 may be fixed to the insulating member 481 of the third subassembly 480. In this way, the rear insulating housing 450 can be secured in multiple directions. Additionally or alternatively, the rear insulating housing 450, the front insulating housing 440 and the stacked first and the second subassembly housings 410 and 420 may also be fixed together by an outer housing 610. The outer housing 610 may be made of a material with greater strength, such as metal. The outer housing 610 may be manufactured by, for example, die-casting, molding or machining. The outer housing 610 may provide adequate mechanical support and protection for the front insulating housing 440, the rear insulating housing 450, the first subassembly 460, the second subassembly 470 and the third subassembly 480. In some embodiments, as shown in FIGS. 2A and 3A, the electrical connector 200 may further comprise a pair of clamping members 620. The pair of clamping members 620 may be provided at two ends of the front insulating housing 440 opposed each other in the longitudinal direction X1-X2. Two legs of each clamping member 620 may be fixed to the front insulating housing 440 and the outer housing 610, respectively, so that the outer housing 610 and the front insulating housing 440 may be fixed.

In some embodiments, as shown in FIGS. 3B, 4 and 5A-5B, in the second mating direction Z2, the first subassembly housing 410 may extend beyond the rear insulating housing 450. Each first subassembly housing 410 may have a notch 413 on a side facing the rear insulating housing 450. An opening of the notch 413 may be oriented toward the rear insulating housing 450. An end of the rear insulating housing 450 provided with the third mating interface 230 may protrude into the notch 413. In this way, the space in the first subassembly housings 410 can also be utilized to accommodate the third mating interface 230. In some embodiments, the third mating interface 230 may overlap with the second mating interface 220 in the longitudinal direction X1-X2, thereby reducing the longitudinal dimension of the electrical connector 200. Accordingly, the third mating interface 230 may have an enlarged length in the longitudinal direction X1-X2. In some embodiments, there may be a larger space for mounting the fourth mating ends 332 of the third conductive elements 330.

In some embodiments, as shown in FIGS. 8A-8B, the plurality of third conductive elements 330 may include differential pairs of signal conductive elements 333 and grounding conductive elements 334. The ground conductive elements 334 may be dispersed among the differential pairs of signal conductive elements 333. In this way, two adjacent differential pairs of signal conductive elements 333 are shielded from each other by the ground conductive element 334. The electrical connector 200 may have improved anti-crosstalk and common mode suppression performances in the context of providing high speed interconnections.

In some embodiments, as shown in FIGS. 8A-8B, the electrical connector 200 may further comprise a shield 500. The shield 500 may be electrically connected to the grounding structure, such as the ground conductive elements 334. The shield 500 may have any suitable configuration, including but not limited to a shielding strip or a shielding frame. The shield 500 may be disposed on a side of the differential pairs of signal conductive elements 333 in the transverse direction Y1-Y2. The shield 500 may be formed from, for example, metallic materials using a molding or stamping process. The shield 500 and the ground conductive elements 334 may cooperate to shield the differential pairs of signal conductive elements 333. In this way, signal transmission speed can be enhanced and signal integrity at higher frequencies can be improved. The electrical connector 200 may have better electrical properties, and the electronic system 100 may have more data channels and/or processing functionalities.

In some embodiments, as shown in FIGS. 8A-8B, the plurality of third conductive elements 330 may be disposed into at least one column parallel to the longitudinal direction X1-X2. Each column of the third conductive elements 330 may have a respective shield 500. Each shield 500 may include an inner shield 510 and an outer shield 520. For each column, the outer shield 520, the third conductive elements 330 and the inner shield 510 may be disposed sequentially in the transverse direction Y1-Y2. In the transverse direction Y1-Y2, the outer shield 520 may be closer to the outer side of the electrical connector 200 than the inner shield 510. In this way, the inner shield 510, the outer shield 520 and the ground conductive elements 334 can form a shielding frame for the differential pairs of signal conductive elements 333. Such a configuration may provide improved shielding and therefore reduce crosstalk and improve signal integrity at higher frequencies. In some embodiments, as shown in FIGS. 8A-8B, for each column, the inner shield 510 and the outer shield 520 may be attached to the insulating member 481. As shown in FIG. 8A, the arrows schematically illustrate an assembly process of the third subassembly 480. First, the third conductive elements 330 and the insulating member 481 may be formed as an integrated member, for example, by an injection molding process. In this way, the third subassembly 480 is achieved. The inner shield 510 and the outer shield 520 may then be attached to two sides of the insulating member 481, respectively. After the inner shield 510, the outer shield 520 and the third subassembly 480 are assembled, they can be inserted into the front insulating housing 440 and the rear insulating housing 450.

In some embodiments, as shown in FIGS. 8A-8B, since the third mating ends 331 and the fourth mating ends 332 at two ends of the third conductive elements 330 are bent toward the inner sides of the first mating interface 210 and the third mating interface 230, respectively, the inner shield 510 is shorter than the outer shield 520 in a length direction of the third conductive elements 330 to avoid short circuits between the inner shield 510 and the third conductive elements 330. For example, as shown in FIGS. 8A-8B, in the extension direction of the ground conductive elements 334, each inner shield 510 may abut against an intermediate portion 334a of each ground conductive element 334 in the corresponding column. Each outer shield 520 abuts against each ground conductive element 334 in the corresponding column on two sides of the intermediate portion 334a. When the corresponding substrates are inserted into the first mating interface 210 and the third mating interface 230, respectively, the third mating ends 331 and the fourth mating ends 332 tend to bend outwardly. The resilience of the mating ends at both ends of the ground conductive elements 334 may be increased with the outer shield 520 abutting against the ground conductive elements 334 on two sides of the intermediate portions 334a. The substrates inserted to the first mating interface 210 and the third mating interface 230, respectively, may be securely clamped.

In some embodiments, as shown in FIGS. 8A-8B, each inner shield 510 may have cantilever beams 511 bent toward the ground conductive elements 334 of the corresponding column. The number of cantilever beams 511 may be the same as the number of ground conductive elements 334 in the corresponding column. The cantilever beams 511 may abut against the ground conductive elements 334 in the corresponding column. For example, a plurality of holes 482 may be provided in the insulating member 481 holding the plurality of third conductive elements 330. The cantilever beams 511 may pass through the holes 482 to abut against the ground conductive elements 334 respectively. The cantilever beams 511 may be resilient and enable reliable electrical contacts between the inner shield 510 and the ground conductive elements 334. Additionally or alternatively, the cantilever beams 511 may support the portions of the inner shield 510 other than the cantilever beams to be spaced apart from the differential pairs of signal conductive elements 333, such that the inner shield 510 and the differential pairs of signal conductive elements 333 are electrically insulated. In some embodiments, as described in FIG. 8A, each ground conductive element 334 may have the intermediate portion 334a. The intermediate portion 334a may correspond to the hole 482 (shown in FIG. 8B) in the insulating member 481. The intermediate portion 334a may be greater than the other portions of the ground conductive element 334 in width. With this configuration, the contact area between the ground conductive element 334 and the cantilever beam 511 of the inner shield 510 may be increased, which may reduce the requirement for positional accuracy of the two, and may facilitate the cantilever beam 511 of the inner shield 510 to abut against the ground conductive element 334.

In some embodiments, as shown in FIGS. 8A-8B, each outer shield 520 may have pleated portions 521 bulging toward the ground conductive elements 334 in the corresponding column. The pleated portions 521 may abut against the ground conductive elements 334 of the corresponding column. In the extension direction of the ground conductive elements 334, the pleated portions 521 may be disposed on two sides of the cantilever beams 511. Each ground conductive element 334 has two pleated portions 521 in electrical connection with each other. Compared with the cantilever beams 511, the pleated portions 521 are relatively less resilient. By providing two pleated portions 521 for each ground conductive element 334, it can be ensured that each ground conductive element 334 can be electrically connected to the outer shield 520. The pleated portions 521 may allow portions of the outer shield 520 other than the pleated portions 521 to be spaced apart from the differential pairs of signal conductive elements 333, such that the outer shield 520 and the differential pairs of signal conductive elements 333 are electrically insulated.

In some embodiments, as shown in FIGS. 8A-8B, the pleated portions 521 may be provided with projections 522 on their surfaces abutting against the ground conductive elements 334 in the corresponding column. There may be multiple projections 522 on each pleated portion 521. Multiple contact points may be formed between each pleated portion 521 and corresponding ground conductive element 334 instead of surface contact. A reliable electrical contact can be formed between the outer shield 520 and each ground conductive element 334. The numbers of projections 522 on the different pleated portions 521 may be the same or different. The projections 522 may be in shape of any other suitable shape, such as circular, rectangular. The projections 522 may project from the pleated portions 521 toward the ground conductive element 334 of the corresponding column. By providing the projections 522, the pleated portions 521 may contact the ground conductive elements 334 of the corresponding column in a centralized manner, so that the contact area can be reduced. Once the parts have machining tolerance, the contacting manner of multiple contact points may provide higher assembly tolerance.

In some embodiments, as shown in FIGS. 8A-8B, the portions of the inner shield 510 that are aligned with the differential pairs of signal conductive elements 333 of the corresponding column may protrude toward two ends of the differential pairs of signal conductive elements 333 to form inner shielding extensions 512. In this way, the length of the inner shield 510 is larger in the extension direction of the ground conductive elements 334, and the inner shield 510 may be more effective in shielding the differential pairs of signal conductive elements 333 of the corresponding column.

In some embodiments, as shown in FIGS. 8A-8B, the portions of the outer shield 520 that are aligned with the differential pairs of signal conductive elements 333 of the corresponding column may protrude toward two ends of the differential pairs of signal conductive elements 333 to form outer shielding extensions 523. In this way, the length of the outer shield 520 is larger in the extension direction of the ground conductive elements 334, and the outer shield 520 may be more effective in shielding the differential pairs of signal conductive elements 333 of the corresponding column.

In some embodiments, as shown in FIGS. 8A-8B, the inner shielding extensions 512 may be shorter than the outer shielding extensions 523 in the extension direction of the differential signal conductive element pair 333. In this way, when the first substrate 111 is connected to the first mating interface 210, and/or the first interface 141 of the first cable connector 140 is connected to the third mating interface 230, the contact pads of the first substrate 111 and/or the contact pads of the first interface 141 may not be likely to be in electrical contact with the inner shielding extensions 512.

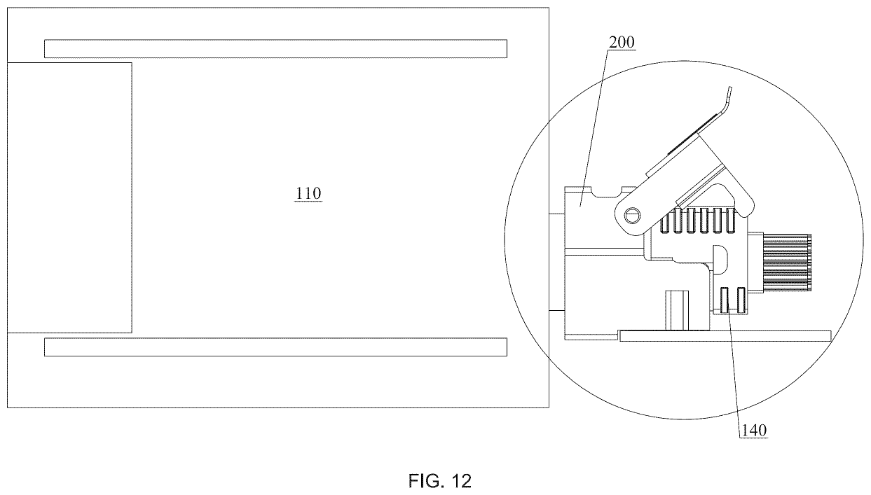

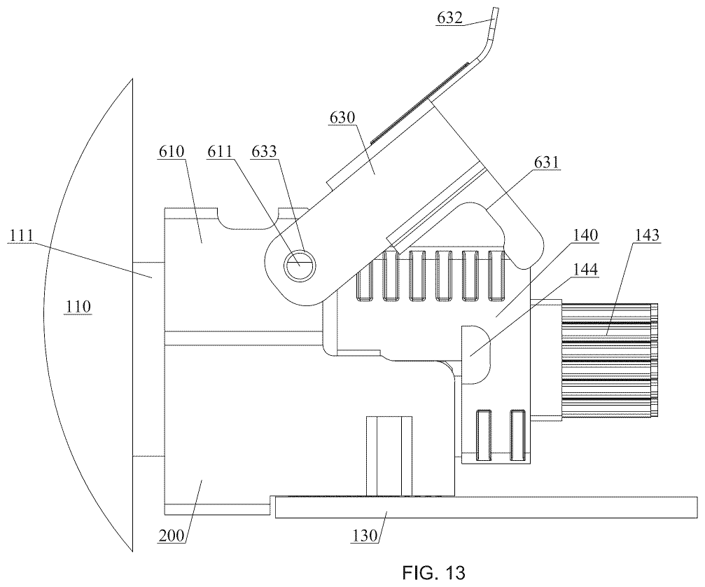

In some embodiments, as shown in FIGS. 2A-2B and 12-13, the electrical connector 200 may further comprises a latch 630. The latch 630 may be pivotably connected to the outer housing 610 between a latched position and an unlatched position. For example, the latch 630 may have a pivoting portion 633. A pivot 611 may be provided on the outer housing 610. The pivoting portion 633 may be pivotably connected to the pivot 611. One of the pivoting portion 633 and the pivot 611 may be a pivot hole and the other may be a pivot pin. After the second mating interface 220 and the third mating interface 230 are connected to the first interface 141 and the second interface 142 of the first cable connector 140, respectively, the latch 630 may be pivoted to the latched position so that the latch 630 can be locked to the first cable connector 140. In this way, the first cable connector 140 can be fixed to the electrical connector 200. For example, the latch 630 may be provided with hooks 631. When the latch 630 is pivoted to the latched position, the hooks 631 may hook engagement features 144 on the first cable connector 140. When the latch 630 is pivoted to the unlatched position, the hooks 631 may be separated from the engagement features 144. In this way, the electrical connector 200 can be separated from the first cable connector 140.

To facilitate pivoting the latch 630, the latch 630 may include an operating portion 632. The operating portion 632 may be disposed opposite the pivoting portion 633. The pivoting portion 633 may have any suitable structure such as a handle. By controlling the operating portion 632, the user experience may be improved. The operating portion 632 may be provided with anti-sliding structures such as bulges and/or recesses.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to these. Any one of the creative features, whether alone or combined with one or more other creative features, can also be used for other types of electrical connectors, such as a card edge connector, a backplane connector, a daughter card connector, a stacking connector, a mezzanine connector, an I/O connector, a chip socket, a Gen Z connector, etc.

Moreover, although many creative aspects have been described above with reference to orthogonal connectors, it should be understood that the aspects of the present disclosure are not limited to these. Any one of the creative features, whether alone or combined with one or more other creative features, can also be used for other types of electrical connectors, such as coplanar connectors, vertical connectors or right angle connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10 +d1 and 20+d2” in some embodiments. The amount of variation d1, d2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation d1, d2 for a value could be as high as 50%. For example, if an operable range extends from 2 to 200,“approximately 80” may encompass values between 40 and 120 and the range may be as large as between 1 and 300. When only exact values are intended, the term “exactly” is used, e.g., “between exactly 2 and exactly 200.” The term “essentially” is used to indicate that values are the same or at a target value or condition to within +3%.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector, comprising:
a first side comprising a first interface elongated in a first column;
a second side opposite the first side and comprising:
a second interface elongated in a second column parallel to the first column, and
a third interface elongated in a third column parallel to the first column; and
a third side perpendicular to the first side and second side, the third side comprising a fourth interface elongated in a mating direction perpendicular to the first column.

2. The electrical connector of claim 1, wherein:
the first, second, and third interfaces are configured to engage with respective interfaces of one or more components; and
the fourth interface is configured to mount to a substrate.

3. The electrical connector of claim 1, comprising:
a first plurality of conductive elements connecting a first portion of the first interface to the fourth interface; and
a second plurality of conductive elements connecting a second portion of the first interface to the third interface.

4. The electrical connector of claim 3, further comprising a first subassembly comprising:
the first plurality of conductive elements extending from the first interface to the fourth interface, and
a first subassembly housing holding the first plurality of conductive elements.

5. The electrical connector of claim 4, further comprising a second subassembly comprising:
a third plurality of conductive elements extending from the second interface to the fourth interface, and
a second subassembly housing holding the third plurality of conductive elements.

6. The electrical connector of claim 5, wherein:
the first subassembly housing and the second subassembly housing are insulative; and
the first subassembly and second subassembly are stacked in a third direction perpendicular to both the first column and the mating direction.

7. The electrical connector of claim 5, further comprising:
a pair of first subassemblies, wherein:
the second subassembly is disposed between the pair of first subassemblies.

8. The electrical connector of claim 7, further comprising:
a third subassembly comprising the second plurality of conductive elements and a third subassembly housing holding the second plurality of conductive elements, wherein:
the pair of first subassemblies and the third subassembly are disposed in the first column.

9. The electrical connector of claim 1, wherein:
the second interface is closer to the fourth interface than the third interface; and
the second interface offsets from the third interface in the mating direction.

10. The electrical connector of claim 1, wherein:
the first interface is configured to receive a card edge; and
the second and third interfaces are configured to connect to cables.

11. The electrical connector of claim 5, wherein:
the first plurality of conductive elements are configured to transmit low-speed signals and/or power;
the second plurality of conductive elements are configured to transmit high-speed signals; and
the third plurality of conductive elements are configured to transmit low-speed signals and/or power.

12. A cable assembly comprising:
a substrate comprising:
a first edge,
a first plurality of pads disposed along the first edge and elongated in a first direction,
a second edge offset from the first edge in the first direction, and
a second plurality of pads disposed along the second edge and elongated in the first direction; and
a plurality of cables terminated to the substrate.

13. The cable assembly of claim 12, wherein:
the plurality of cables are connected to the first plurality of pads and the second plurality of pads through the substrate.

14. The cable assembly of claim 12, further comprising:
a housing at least partially holding the substrate, the housing comprising an engagement feature configured for engaging with a latch.

15. An electronic system, comprising:
a first substrate, a second substrate, and a third substrate; and
an electrical connector comprising:
a housing;
a first interface through the housing disposed on a first side of the electrical connector and electrically connected to the first substrate;
a second interface through the housing disposed on a second side of the electrical connector, opposite the first side, and electrically connected to the second substrate;
a third interface through the housing disposed on the second side of the electrical connector; and
a fourth interface through the housing disposed on a third side of the electrical connector, the third side extending between the first side and the second side, the fourth interface electrically connected to the third substrate.

16. The electronic system of claim 15, wherein:
the second substrate is electrically connected to the second interface by a cable assembly having a cable connector, the second interface being configured to receive the cable connector.

17. The electronic system of claim 16, wherein:
the second substrate is further electrically connected to the third interface.

18. The electronic system of claim 16, wherein:
the electrical connector further comprises a latch pivotably attached to the housing adjacent the third interface, the latch configured to fix the cable connector to the electrical connector when the latch is placed in a latched position.

19. The electronic system of claim 15, wherein the electrical connector is configured to:
electrically connect the first substrate with the second and third substrates; and
electrically connect the second substrate with the third substrate.

20. The electronic system of claim 16, wherein the electrical connector is configured to:
transmit low-speed signals and/or power from the first interface through first conductive elements mounted to the third substrate and second conductive elements connected to both the cable assembly and the third substrate; and
transmit high-speed signals from the first interface through third conductive elements connected to the cable assembly.
